(19) United States
(12) Patent Application Publication
(10) Pub. No.: US 2023/0089858 A1
(43) Pub. Date: Mar. 23, 2023

(54) WAVE ENERGY CONVERSION SYSTEM

(71) Applicant: BOMBORA WAVE POWER EUROPE LTD, Pembrokeshire (GB)

(72) Inventors: Paul VIGARS, Frampton Cotterell (GB); David Charles RIGG, Bath (GB); James Samuel LEIGHTON, Tenby (AU); Campbell Robert ALGIE, Okiwi Bay (NZ); Sam LEIGHTON, Carmarthen (GB)

(73) Assignee: BOMBORA WAVE POWER EUROPE LTD, Pembrokeshire (GB)

(21) Appl. No.: 17/802,693

(22) PCT Filed: Mar. 19, 2021
(86) PCT No.: PCT/EP2021/057156

§ 371 Date: Aug. 26, 2022

(30) Foreign Application Priority Data
Mar. 19, 2020 (GB) 2004016.8

(51) Int. Cl. F03B 13/14; F03B 11/08

(52) U.S. Cl. CPC F03B 13/14; F03B 11/08

(57) ABSTRACT

A WEC module for connection to a WEC system having a power take-off (PTO) configured to generate electricity in response to fluid flow in a fluid flow path of the system. The module includes a mounting portion for releasably mounting the module to the system, a deformable sealing member configured to provide a sealed fluid connection between the module and the fluid flow path, and a working surface configured to exchange, in response to wave motion, a working fluid with the fluid flow path via the sealed fluid connection. Also disclosed is a WEC system and a method of deploying the WEC module. Also disclosed is an installation device for a working surface and a method of installing a working surface.

### TECHNICAL FIELD

The present disclosure relates to a wave energy converter (WEC) system, a WEC cell and method of deploying a WEC cell. The present disclosure also relates to an installation device for installing a working surface and a method of installing a working surface.

### BACKGROUND

Wave energy conversion systems for generating electrical energy from wave energy are well known. A number of different systems have been proposed including oscillating water column devices and pressure differential converters.

Oscillating water column (OWC) devices harness energy from the vertical oscillation of seawater inside an open-ended, typically cylindrical chamber. The chamber is semi-submerged with the lower end of the chamber being open to the water with a trapped air pocket at the upper end. Waves force the column of water within the chamber to act like a piston which, in traditional OWCs, moves to force air in and out of the chamber. This results in a flow of air which is either channelled through a bidirectional turbine in a power take-off system or through a valve system through a unidirectional turbine.

These OWC devices often require water to change direction and flow around non-streamlined edges. This increases friction and energy losses within the system and can introduce lag which can prevent good coupling with the wave motion. OWC devices also typically require a considerable amount of material in their construction, installation and anchoring relative to the power output of the systems. The bidirectional turbine is exposed to salt-laden air which can increase the costs for corrosion resistance and maintenance costs of the turbine.

Submerged pressure differential converters (some of which are also known as membrane power conversion devices/converters or membrane-pneumatic power conversion devices/converters) use the difference in hydrostatic pressure at different locations below a wave (depending on the vertical height of water above the converter) to produce a pressure difference within cells connected to a closed power take-off system. The pressure difference results in flow of a low inertia, low friction energy transfer fluid (e.g. air) within the closed power take-off system which transmits energy to a turbine and electrical generator (which are not exposed to any salt-laden air).

The cells are each typically provided with a flexible (usually fibre-reinforced industrial rubber) membrane as the working surface between the seawater and the closed power take-off system, the flexible membrane allowing for a large change in the geometry of the working surface which can be used to provide a large swept cell volume. The fibrous reinforcement of the membrane protects it from excessive loads in extreme conditions.

Bombora's mWave™ system is an example of a submerged pressure differential converter and features a series of air-filled cells mounted on the seabed. Each cell is defined by a cell body having a concave cell wall and an inflated, dome-shaped flexible rubber membrane working surface which is angled to the direction of the incoming waves. As a wave passes over the cells, the flexible membrane geometry responds to the hydrostatic pressure of the wave and air inside the cells is squeezed into a duct (through a one-way check valve provided in the cell wall) and through a turbine. A generator uses the rotation of the turbine to produce electricity. The air is recycled to re-inflate the membrane ready for the next wave.

One issue with such systems is that, because they are submerged under water, it can be difficult to maintain or repair components of these systems. In some cases, repair may require shutdown of the system, which can be costly for an operator of the system.

There is a desire to provide a WEC cell that ameliorates at least some of the problems associated with the known systems.

### SUMMARY

According to a first aspect of the present invention, there is provided a wave energy conversion (WEC) module for connection to a WEC system having a power take-off (PTO) configured to generate electricity in response to fluid flow in a fluid flow path of the system, the WEC module comprising:
a mounting portion for releasably mounting the module to the system;
a deformable sealing member configured to provide a sealed fluid connection between the module and the fluid flow path; and
a working surface configured to exchange, in response to wave motion, a working fluid with the fluid flow path via the sealed fluid connection.

The provision of the working surface and sealing member as part of a WEC module may allow those components to be disconnected from the system for the purpose of e.g. maintenance, repair or replacement. The provision of a deformable sealing member may ensure that a seal is maintained between the module and the fluid flow path, even when the module is submerged (i.e. below the free surface of a body of water).

Optional features will now be set out. These are applicable singly or in any combination with any aspect.

The working surface may be in the form of a membrane. The membrane may be an elastic membrane. The working fluid may be a gas, such as air.

The module may be in the form of a WEC cell comprising a cell body. The cell body may define an aperture and the working surface may seal the aperture. The cell body and the working surface may define a chamber for storage of working fluid. The cell body may have a concave surface partly defining the chamber. The concave surface may be a limit surface (the working surface may contact (e.g. lie against) this surface upon deflation in use).

In some embodiments, the module may comprise a plurality of (e.g. two) cell bodies, and a plurality working surfaces, each defining corresponding (e.g. separate) chambers for working fluid.

The module may comprise a fluid exchange port for exchanging fluid between the chamber and the fluid flow path of the system. The fluid exchange port may be in the form of an aperture. The fluid exchange port may be provided on the concave surface of the cell body. The fluid exchange port may comprise a module sealing face for sealing with a corresponding system sealing face (i.e. at an opening to the fluid flow path). The deformable sealing member may be disposed on the module sealing face. The module sealing face may be generally planar (for sealing against a corresponding planar system sealing face). The module sealing face may extend (e.g. circumferentially) about an opening of the fluid exchange port. The deformable sealing member may extend about an opening of the fluid exchange port.

The fluid exchange port may comprise a moveable portion. The module sealing face may form part of the moveable portion. In this respect, the deformable sealing member may be disposed on the moveable portion. The moveable portion may be moveable between a retracted position and a sealing position in which the deformable sealing element seals against the system sealing face. The moveable portion may be moveable along an adjustment axis. The adjustment axis may be substantially parallel to the direction of fluid flow through the port (and/or substantially perpendicular to the plane of the sealing face). Alternatively, the moveable portion may be moveable e.g. radially outward or inward.

The position of the moveable portion along the adjustment axis may be adjustable by way of an adjustment mechanism. The adjustment mechanism may comprise a threaded rod connecting the moveable portion to the fluid exchange port (e.g. to a stationary portion of the fluid exchange port).

The adjustment mechanism may comprise a biasing device for biasing the moveable portion toward the sealing position. The biasing device may bias the moveable portion in a direction along the adjustment axis away from the fluid exchange port. In other words, the biasing device may be configured to urge the moveable portion towards the system sealing face.

Upon abutment between the sealing faces (e.g. via the sealing member), the moveable portion may be moved by the system sealing face (i.e. against the bias of the biasing device). In this way, the biasing device may urge the module sealing face towards the system sealing face so as to enhance the seal formed therebetween.

In other embodiments, the module and system sealing faces may be circumferential surfaces. Thus, for example, the module sealing face may be configured to circumferentially surround, or be circumferentially surrounded by, the system sealing face. In such embodiments, the sealing member may extend circumferentially about the module sealing face. The sealing member may project substantially radially from the module sealing face (i.e. either inwardly or outwardly) towards the system sealing face (i.e. so as to extend across any gap formed between the sealing faces in use). The sealing member may comprise a plurality of radially extending projections spaced from one another along the module sealing face. The or each projection may be inclined from the radial axis.

The sealing member may be inflatable. Thus, the sealing member may comprise an internal cavity that is configured to be filled with a fluid for inflation of the sealing member. The sealing member may, for example, be in the form of a tube (e.g. an annular tube).

In some embodiments, the module may comprise a plurality of fluid exchange ports. The deformable sealing member may be configured to provide a sealed connection for a plurality of fluid exchange ports. Thus, for example, the deformable sealing member may extend around a plurality of fluid exchange ports (i.e. on a system-facing surface), such that the fluid exchange ports bounded by the sealing member are sealed from the external environment when the module is connected to a WEC system.

In one example, the deformable sealing member may extend about a periphery of the module, such as a periphery of the cell body (e.g. a periphery of a system-facing surface of the module/cell body). In other words, the deformably sealing member may extend about a periphery of the aperture.

Alternatively, each fluid exchange port may comprise a dedicated deformable sealing member (i.e. each may be as described above).

The module may comprise an inlet port for fluid flow into the module and an outlet port for fluid flow out of the module. The or each fluid exchange port may comprise a valve (e.g. a one-way valve) to restrict flow to a single direction through the port. The port may additionally or alternatively comprise a shut-off valve that allows the prevention of fluid flow through the port. The shut-off valve may, for example, be used during deployment of the module.

The module may comprise a sump. The sump may be arranged at an in-use low-point of the chamber or may be fluidly connected to an in-use low point of the chamber, for the collection of liquids (e.g. water) in the chamber. The sump may comprise, or may be in fluid connection with, a pump for discharging liquid from the sump.

In other embodiments, the fluid exchange port may be arranged for discharge of liquid from the chamber. Thus, the fluid exchange port may be in fluid connection with an in-use low-point of the chamber. The fluid exchange port may be arranged on a decline from the low-point so as to be configured to drain liquid from the chamber. Thus, liquid may be drained from the chamber to the fluid flow path of the system via the fluid exchange port.

In some embodiments, the module may be configured to mount to a base structure of the system (that may comprise the fluid flow path and the PTO).

The mounting portion may be a first mounting portion, and the module may comprise a second mounting portion spaced from the first mounting portion.

One or both of the first and second mounting portions may be moveable, such that a distance between the mounting portions may be altered. In this respect, the first and second mounting portions may be moveable between a retracted position in which they are separated by a first distance, and an expanded position in which they are separated by a second distance that is greater than the first distance.

The or each mounting portion may be in the form of a pin, bar, projection, hook, groove, recess, etc. The or each mounting portion may be connected to the module (e.g. cell body) by an actuator, such as a ram (e.g. a hydraulic ram). In this way, the or each mounting portion may be moveable by the actuator (e.g. between the retracted and expanded positions).

In one embodiment, the first mounting portion may be disposed at an in-use upper end of the module (or cell), and the lower mounting portion may be disposed at an in-use lower end of the module. The first mounting portion may be a fixed mounting portion, while the second mounting portion may be movably connected to the module (e.g. cell body) by way of an actuator. In this way, the module may be mounted to a structure by engaging the first mounting portion with a first receiving portion of the structure, and then moving the second mounting portion (i.e. to the expanded position) to engage a second receiving portion of the structure. The expansion of the mounting portions into the receiving portions may thus lock the module with respect to the base structure.

The or each mounting portion may be mounted to the module (e.g. cell body) by way of an over-centre mechanism. The over-centre mechanism may comprise first and second linkages connected to one another at a central pivot point. The mounting portion may be disposed at a distal end of the over-centre mechanism. A proximal end (opposite the distal end) may be pivotably connected to the module (e.g. cell body of the module). An actuator (e.g. a hydraulic ram) may be connected between the central pivot point and the module (e.g. cell body).

In another embodiment, both the first and second mounting portion may be fixed mounting portions. The first and/or second mounting portion may comprise an aperture for receipt of a pin. The aperture may be oriented in a substantially in-use horizontal plane (i.e. for a receipt of a vertically extending pin). The first and/or second mounting portion may comprise a pin. The pin may be tapered (i.e. inwardly to a distal end of the pin). The pin may be arranged for receipt in an aperture (e.g. of the base structure). The pin may extend substantially vertically in-use (i.e. during mounting of the module to the base structure). The pin may extend downwardly in-use.

The module may further comprise a ballast weight. The ballast weight may have sufficient mass so as to prevent movement of the module due to wave motion. The ballast weight may, for example, have a weight of 150 to 500 kg. In general, the ballast weight may be chosen such that the total weight of the cell module (i.e. including the ballast weight) exceeds the sum of the maximum buoyancy force and the hydrodynamic heave load experienced by the module. An underside of the ballast weight may comprise a recess or protrusion for engagement with a recess or protrusion of the base structure of the system.

In some embodiments, the module may comprise a support frame defining an aperture sealed by the working surface.

The support frame may form part of the cell body (i.e. the aperture defined by the support frame may be the aperture of the cell body). Alternatively, the support frame may be configured for mounting to a cell body forming part of the WEC system (e.g. forming part of a base structure of the WEC system). When the support frame is mounted to the cell body, the support frame, working surface and cell body may define a chamber for storage of a working fluid (i.e. the module may be configured so as to only form a chamber when connected to the WEC system (e.g. mounted to the cell body)). In such embodiments the module may not include a cell body (e.g. no structure may extend across the aperture defined by the support frame). One benefit of providing a support frame (rather than e.g. attaching a working surface directly to the cell body) is that it allows pre-tensioning of the working surface (when elastic) prior to installation. Such pre-tensioning may be difficult to perform on a cell body that is submerged.

The support frame may be obround. The support frame may comprise a ring member (which may be in the form of an aperture tube) formed in a ring shape (e.g. an obround ring shape) so as to define the aperture (e.g. an obround aperture). The support frame may comprise a skirt depending from the ring member (e.g. extending away from the working surface). The support frame may comprise an inner and/or outer skirt depending from the ring member (e.g. extending away from the working surface).

The support frame may comprise a base member (e.g. in the form of a base plate) configured to seat on a surface of a base structure of the WEC system (e.g. on a cell body of the system) when the module is connected thereto. The base member may extend (e.g. outwardly) from the skirt of the support frame. The base member may extend transversely between the inner and outer skirts. The base member may extend about (e.g. entirely about) the aperture defined by the support frame. That is, the base member may extend about a periphery of the aperture/support frame.

A surface of the base member may define a module sealing face for sealing against a sealing face of the base structure of the system. The deformable sealing member may be disposed on the module sealing face of the base member. The deformable sealing member may extend about (e.g. entirely about) the aperture defined by the support frame (e.g. along the module sealing face of the base member). That is, the deformable sealing member may extend about (and thus seal) a periphery of the support frame.

The support frame may comprise a guide portion (e.g. a peripheral guide portion) configured to guide the module onto the base structure (e.g. cell body) of a WEC system. The guide portion may extend about the aperture defined by the support frame (e.g. may extend substantially entirely about the aperture). The base structure may, for example, be a cell body when the module does not include a cell body. The guide portion may comprise one or more surfaces arranged to engage one or more corresponding surfaces of the base structure during connection of the module to guide the module onto the base structure. The one or more surfaces of the guide portion may taper outwardly in a direction of movement of the module during connection with the base structure (i.e. may taper outwardly in a direction away from the working surface).

The guide portion (e.g. the one or more surfaces of the guide portion) may define a cavity and an opening for receipt of a portion of the base structure into the cavity. The cavity may be tapered outwardly in the direction of movement of the module during connection with the base structure (i.e. tapered inwardly in a direction to the working surface. The one or more surfaces of the guide portion defining the cavity may seat on (e.g. a correspondingly tapered) outer surface of the base structure when mounted thereto.

Once seated on the base structure, the guide portion may help to reduce movement of the module. This may especially be the case where, for example, the guide portion extends about the entire (or substantially the entire) aperture so as to receive the portion of the base structure therein.

The guide portion may depend from the ring member and/or skirt of the support frame. The guide portion may extend along the ring member and/or skirt (i.e. so as to extend about a periphery of the aperture). The guide portion may comprise plurality of webs depending from the ring member and/or the skirt and spaced from one another about the aperture (defined by the ring member). The webs may be in the form of plates. Inner edges/surfaces of the webs may define the tapered cavity.

The support frame may comprise a moveable portion. The module sealing face may form part of the moveable portion. The moveable portion may be moveable between a retracted position and a sealing position in which the deformable sealing element seals against the system sealing face. The moveable portion is moveable along an adjustment axis that is substantially perpendicular to the module sealing face.

The module (e.g. support frame) may comprise a biasing member for biasing the moveable portion towards the sealing position.

The module may comprise a plurality of mounting portions spaced (e.g. evenly) about a periphery of the module. The mounting portions may be spaced about a periphery of the support frame. That is, the mounting portions may be spaced about a periphery of the aperture defined by the support frame (or cell body).

The one or more mounting portions may be rearward of the ring member of the support frame.

The support frame may comprise one or more locks for selectively locking the support frame to the cell body of a base structure of the system (i.e. the mounting portion of the module may be in the form of the one or more locks). The locks may project from the base member (e.g. base plate). Each lock may be in the form of a releasable lock, such as a twist lock whereby the lock is received in a recess or aperture of the cell body (or base structure) and is rotatable between unlocked and locked positions. In some embodiments, the locks may be operatively connected so as to be moveable by a single actuator.

In other embodiments, the mounting portion may be in the form of hooks spaced about a periphery of the support frame (for hooking onto the base structure). The mounting portion may be in the form of a plurality of apertures or recesses spaced about the periphery of the support frame.

Alternatively or additionally, the mounting portion of the support frame may be in the form of one or more peripheral projections (e.g. a peripheral lip). In this case, the base structure may comprise a clamp or lock for engaging the one or more peripheral projections (e.g. peripheral lip).

The module may be configured such that, when mounted to the WEC system, the working surface extends along a substantially horizontal plane. Embodiments in which the WEC module comprises a support frame and a guide portion may be particularly suited to this horizontal configuration.

Alternatively, in some embodiments, the module may be configured such that, when mounted to the WEC system, the working surface extends along a plane that is inclined with respect to horizontal. In some embodiment, the module may be configured such that, when mounted to the WEC system, the working surface extends along a substantially vertical plane.

In some embodiments, the module may comprise an external structure that extends over an (in-use) external surface of the working surface. The external structure may extend from the support frame and/or cell body. The external structure may be configured to structurally support the support frame and or cell body.

The external frame may be in the form of a working surface restrictor configured to limit expansion/distension of the working surface. Such a restrictor may avoid damage to the working surface due to excessive expansion/distension. The working surface restrictor may be in the form of a cage. The cage may be rigid (e.g. may be formed of a plurality of rigid members). Alternatively, the cage may be flexible (e.g. may be formed of a plurality of flexible members such as straps).

The restrictor (e.g. cage) may comprise one or more engagement points to allow manoeuvring of the device by e.g. a handling tool (such as a winch). In this respect, the restrictor may provide dual functionality.

The module may be configured to be submerged (i.e. located entirely below the free surface of a body of water).

The module may comprise a power source, such as a battery.

The module may comprise instrumentation, such as a sensor for detecting an operating characteristic of the module or a characteristic of the environment surrounding the module.

The module may comprise a communication device for communicating remotely and/or with a base structure when connected thereto. The communication device may be configured for wireless communication (e.g. via a Wi-Fi or cellular network). In this respect, various portions of the module may be controlled remotely. For example, the or each moveable mounting portion may be configured for remote control (i.e. may be actuated via a signal received from a remote location).

The module may comprise a sonar device for emitting and/or receiving sonar signals.

The module may comprise a connector for electrical connection with the base structure. The connector may be configured for communication and/or power transfer between the base structure and the module.

In a second aspect there is provided WEC system comprising:
a power take-off (PTO) device for generating electricity from flow of a working fluid;
a fluid flow path in fluid connection with the PTO device;
a plurality of WEC modules, each module fluidly connected to the fluid flow path and configured to exchange working fluid with the fluid flow path in response to wave motion;
a plurality of fluid exchange ports, each fluid exchange port releasably connecting a respective module to the fluid flow path; and
one or more deformable sealing elements arranged to seal the connections between the modules and the fluid flow path.

Each WEC module may be as described above with respect to the first aspect. Each WEC module may be as described below with respect to the fifth aspect.

The fluid flow path may be at least partly defined by the plurality of WEC modules. In some embodiments, the fluid flow path may be entirely defined by the plurality of WEC modules. Thus, for example, the WEC modules may be mounted to one another and the fluid exchange ports may connect each module to an adjacent module for fluid exchange therewith. In such embodiments, the WEC modules may be secured to the seabed. In other embodiments, the WEC modules may be submerged (e.g. fully submerged so as to be entirely below the free surface of the body of water) and may be tethered to the seabed. Alternatively, the WEC modules may define a floating structure, and may be tethered to the seabed.

In other embodiments, the fluid flow path may be at least partly defined by a base structure (e.g. defined by a duct or ducts of the base structure). Thus, the WEC modules may connect to the base structure. The base structure may, for example, be a permanent structure fixed to the seabed. In other embodiments, the base structure may be submerged (e.g. fully submerged so as to be entirely below the free surface of the body of water), and may be tethered to the seabed. Alternatively, the base structure may be a floating structure, and may be tethered to the seabed.

The base structure may comprise the one or more deformable sealing element. In some embodiments, where the modules connect to a base structure, each WEC module may be as described above, except for the inclusion of deformable sealing member(s). That is, the WEC modules may not comprise the described deformable sealing member(s) of the first aspect (because the deformable sealing member(s) may instead be provided as part of the base structure).

The base structure may comprise a frame for supporting the WEC modules. In such embodiments, the fluid exchange ports may form part of the base structure or the WEC modules. The fluid exchange ports may each be as described above with respect to the first aspect. Thus, each fluid exchange port may comprise a moveable portion that may be adjustable along an adjustment axis and may be biased towards an opposing sealing face.

The PTO may comprise a turbine. The turbine may be disposed within the fluid flow path, such that fluid flowing along the fluid flow path causes rotation of the turbine. The PTO may form part of a PTO module that is releasable from the system (e.g. releasable from a base structure). Thus, for example, the PTO module may comprise a mounting portion for mounting the PTO module to the base structure. The PTO module may comprise one or more deformable seals for forming a sealed fluid connection between the PTO and the fluid flow path. The PTO module may comprise one or more fluid exchange ports for providing the sealed fluid connection with the fluid flow path.

The fluid flow path may be defined by a duct or a plurality of interconnected ducts. The duct(s) may comprise a debris separator. The debris separator may comprise a grille. The grille may be upstream of the power take-off device (e.g. turbine). The grille may extend across the duct (i.e. so as to be generally perpendicular to fluid flow through the duct).

Alternatively, the grille may be inclined with respect to the direction of fluid flow through the duct. The grille may be disposed in a portion of the duct that is substantially horizontal. The incline of the grille may be such that an upper end of the grille is upstream of a lower end of the grille. In such embodiments, the debris separator may comprise a debris trap upstream of the grille. The debris trap may be in the form of a recess (e.g. sump) formed in a lower portion of the duct proximate the grille. The incline of the grille (and position of the debris trap) may be such that the grille at least partially overhangs the debris trap. In this way, debris that is blocked (or captured) by the grille may fall (due to gravity) into the debris trap.

In some embodiments the debris separator may be disposed in a substantially vertical portion of the duct. In such embodiments, the grille may extend (e.g. horizontally) across the substantially vertical portion of the duct. The debris separator may comprise a debris trap (e.g. recess or sump) disposed at a lower end of the vertical portion of the duct. In this way, debris that is blocked by the grille may fall into the debris trap.

In some embodiments, the debris separator may comprise a centrifugal separator. The centrifugal separator may be disposed in a substantially vertical portion of the duct. Fluid flow in the duct may pass through the centrifugal separator, which may operate to separate debris from the fluid flow (e.g. for discharge from the duct).

As noted above, each WEC module may be as described above with respect to the first aspect. Thus, for example, each WEC module may comprise first and second mounting portions, which may be moveable between a retracted and expanded position.

The base structure may comprise a plurality of docking stations, each for receipt of a respective WEC module. Each docking station may comprise first and second receiving portions for engagement with the first and second mounting portions of the WEC module. Each receiving portion may comprise a recess for receipt of a mounting portion of a WEC module. The mounting portions of the WEC modules may be in the form of pins oriented so as to be substantially horizontal in-use (i.e. upon mounting of the module to the base structure). Each receiving portion recess may thus be configured for a receipt of a horizontally oriented pin.

The first receiving portion of each docking station may be an upper receiving portion and the second receiving portion may be a lower receiving portion. At least one of the receiving portions may comprise a guide surface inclined from a (rearward) proximal end to a (forward) distal end. The guide surface may be configured to receive a mounting portion of a WEC cell at the distal end and guide the mounting portion, by way of the slope of the guide portion (and gravity), into the recess of the receiving portion. The guide surface may be formed on a projection (e.g. a forwardly projecting portion) of the receiving portion.

The term “forward” is used to describe a direction generally towards a WEC module when being mounted to the base structure, while the term “rearward” is used to describe the opposite direction.

At least one of the receiving portions may define a hook-shaped recess. The hook-shaped recess may comprise an entrance region that extends in a generally rearward direction, and a locking region that extends at an angle to the rearward direction (e.g. perpendicular to the rearward direction). Thus, for example, the locking region may extend upwards or downwards from the entrance region. In this way, the mounting portion may be guided into the entrance region by the guide surface, and upon movement into the expanded position, the mounting portion may be moved into the locking region. The locking region may be configured such that movement of the mounting portion out of the recess is prevented or restricted.

In other embodiments, where each WEC module comprises fixed mounting portions, each docking station may comprise one or more apertures, each for a respective pin of a WEC module mounting portion. The aperture may be oriented for receipt of a substantially vertical pin. This may allow for each WEC module to be lowered onto the docking station. Alternatively or additionally, each docking station may comprise or one or more tapered pins, each for insertion into a corresponding aperture of a WEC module mounting portion. Each pin may be oriented substantially vertically (again, this may allow a WEC module lowered onto a docking station).

In some embodiments the receiving portions and mounting portions as described above may be switched such that each dock station comprises the above described mounting portions and the modules comprise the above described receiving portions. Thus, for example, each docking station may comprise first and second mounting portions moveable between contracted and expanded positions (i.e. for engagement with corresponding receiving portions of a module).

In embodiments where each WEC module comprises a working surface (e.g. in the form of a membrane) and a support frame, each docking station may comprise a cell body. Each cell body may comprise a recess for defining a chamber (with the working surface and the support frame) when the WEC module is mounted thereto. On the other hand, in embodiments where the WEC module comprises a cell body, each docking station may comprise a recess (e.g. defined by a concave surface) for receipt of the cell body.

The docking station (e.g. cell body) may comprise receiving portions in the form of locking holes or apertures. Each locking hole or aperture may be for receipt of a respective lock of the WEC module. In other embodiments, the WEC module may comprise locking holes or apertures and the docking station (e.g. cell body) may comprise locks, such as twist locks, for receipt therein.

In some embodiments each docking station may comprising one or more receiving portions configured to engage with one or more peripheral projections of a corresponding module. The receiving portion may be configured to move (e.g. slide or rotate) from an expanded configuration, in which it is radially outward (from the module) to a contracted position in which it is radially inward (e.g. towards the module). Each of these receiving portions may be in the form of e.g. a clamp (such as a sliding clamp) for clamping onto a projection.

In some embodiments, each docking station may comprise a receiving portion configured for receipt of a mounting portion of a working surface of a module. In such embodiments, the module may be mounted to (and retained on) the docking station by way of the working surface. This receiving portion may, for example, be in the form of a rim, projection(s) (e.g.

peripheral projection), loops, lugs, hook that mounting portion(s) of the working surface can engaged.

Each docking station (e.g. cell body) may comprise a peripheral lip (surrounding the recess). The peripheral lip may taper outwardly in a rearward direction (i.e. in a direction of movement of the WEC module during connection with the docking station). Thus, an outer circumferential surface of the lip may be sloped with respect to the forward/rearward axis. When the WEC module comprises a guide portion (as described above with respect to the first aspect), the guide portion may seat/rest on the outer circumferential surface of the peripheral lip.

A deformable sealing member may be provided on the peripheral lip (e.g. may extend about the recess of the docking station/cell body). The deformable sealing member may extend about the entire periphery of the cell body/docking station.

The peripheral lip may comprise an inner circumferential surface. The inner circumferential surface may partly define the chamber (and may form part of the concave/limit surface of the cell body) when the docking station is in the form of a cell body. When the WEC module comprises a skirt (as described above in the first aspect), the skirt may be shaped so as to form a substantially continuous surface with the inner circumferential surface of the lip. This may provide a smooth surface against which the working surface may lie when in the deflated position.

Each docking station may comprise a connector for supplying power to a corresponding WEC module mounted thereto. The connector may comprise a wet-mate connector. The connector may be moveable between an activated (extended position) and a deactivated (retracted) position. The connector may be configured to move from the deactivated position to the activated position upon detection of the presence of a WEC module at the docking station. Each WEC module may comprise a corresponding connector for (e.g. electrical) connection with the connector. Each connector may be operatively (e.g. electrically) connected to the actuator of the WEC module (e.g. hydraulic ram). Thus, connection of the docking station connector with the WEC module port may initiate movement of the actuator and thus movement of the mounting portions from the retracted position to the expanded position.

Each docking station (e.g. when in the form of a cell body) may comprise a pump for pumping water therefrom. This may be used after connection of a module comprising a support frame and working surface (without a cell body) to discharge water from the chamber defined between the working surface and the cell body.

In a third aspect there is provided a buoyancy tool configured to deploy a WEC module, the buoyancy tool comprising spaced first and second hulls for receipt of a WEC module therebetween, and a gantry extending across the first and second hulls for suspending the WEC module therefrom. The first and second hulls may be parallel. The buoyancy tool may comprise third and fourth parallel hulls extending transversely between the first and second hulls.

The hulls of the buoyancy tool may form a substantially rectangular shape and may define a substantially rectangular aperture therebetween.

The buoyancy tool may comprise a plurality of mooring winches, each comprising an extendable and retractable mooring line for connecting the buoyancy tool to a corresponding mooring. The buoyancy tool may comprise four mooring winches. A mooring winch may be disposed at each hull intersection (i.e. at corners of the buoyancy tool).

The gantry may comprise a winch for suspending the WEC module from the buoyancy tool.

The buoyancy tool may be in the form of a barge.

In a fourth aspect there is provided a method of deploying a modular WEC module on a base structure, the method comprising:
suspending the WEC module from a buoyancy tool;
positioning the buoyancy tool above the base structure;
lowering the WEC module, in a first lowering movement, to the base structure so as to engage a first mounting portion of the WEC module with a first receiving portion of the base structure; and
lowering the WEC module, in a second lowering movement subsequent to the first lowering movement, to engage a second mounting portion of the WEC module with a second receiving portion of the base structure.

The buoyancy tool may be as described above with respect to the third aspect. The WEC module and base structure may be as described above with respect to the first and second aspects.

The engagement between the first mounting portion and second mounting portion may be such that the second lowering movement causes pivoting of the WEC module about the first mounting portion.

The method may further comprise moving mounting portions of the WEC module, for mounting to the base structure, from a retracted position, in which they are separated by a first distance, to an expanded position in which they are separated by a second distance greater than the first distance.

One or both of the receiving portions may comprise a recess for receipt of a respective mounting portion. The recess may comprise an entrance region extending in a first direction from the opening to the recess, and a locking region extending from the entrance region at an angle to (e.g. perpendicular to) the entrance region. The movement of the mounting portions to the expanded position may cause movement of one or both of the movement portions into a respective locking region of a corresponding receiving portion recess.

The method may further comprise electrically connecting the base structure to the WEC module. The method may comprise, upon detection of mounting of the WEC module to the base structure, electrically connecting the base structure to the WEC module (e.g. via an extendable/retractable connector).

The method may comprise, prior to moving the WEC module so as to be above the base structure, at least partly filling the WEC module (e.g. a working fluid chamber of the module).

Positioning the WEC module above the base structure may comprise connecting a plurality of mooring lines of the buoyancy tool to a corresponding plurality of moorings and extending and/or retracting the mooring lines to adjust the position of the buoyancy tool.

According to a fifth aspect of the present invention, there is provided a wave energy (WEC) module for connection to a WEC system having a power take-off (PTO) configured to generate electricity in response to fluid flow in a fluid flow path of the system, the WEC module comprising:
a mounting portion for releasably mounting the module to the system;
a seal assembly providing a sealed fluid connection between the module and the fluid flow path; and
wherein the module is configured to exchange, in response to wave motion, a working fluid with the fluid flow path via the sealed fluid connection.

The module of the fifth aspect may be as otherwise described above with respect to the first aspect.

According to a sixth aspect of the present invention there is provided a portable installation device for installing a working surface on a cell body (e.g. a submerged cell body), the installation device comprising a body defining an opening and one or more mounting portions at a periphery of the opening configured for releasable mounting of a working surface to the body so as to extend across the opening.

The term “portable” is used to describe a device that does not form part of a cell body itself but instead can be manoeuvred (e.g. by a handling device) to move a working surface to a cell body and then install the working surface on the cell body. That is, the installation device is configured for temporarily carrying/holding a working surface such that it can be moved to the cell body and the working surface can be moved from the installation device to a cell body.

The body may be configured to support the working surface in a pre-tensioned (e.g. expanded/stretched) configuration.

The body may comprise a connection portion for connecting a handling device thereto (i.e. for manoeuvring the installation device to install the working surface of a cell body).

The or each mounting portion may be configured for release of the working surface therefrom. For example, the mounting portions may comprise (e.g. actuatable) locks or clamps moveable from an engaged position to a disengaged position.

The body may define a cavity, and the opening may be an opening to the cavity. The mounting portions may be configured such that, when a working surface is mounted thereto, the working surface seals the cavity (i.e. seals the opening to the cavity). The body may further comprise an outlet arranged for fluid flow from the cavity when a working surface seals the opening.

The provision of such an arrangement may facilitate installation of a working surface onto a submerged cell body. The ability for fluid to flow out of cavity when a working surface is mounted thereto means that, as the installation device is lowered in a body of water, fluid will flow out of the cavity due to increasing external pressure. This, in turn, results in the working surface (mounted thereto) being drawn into the cavity (i.e. the working surface is sucked into the cavity).

The body may comprise a plurality of outlets. The provision of a plurality of outlets may provide a more even distribution of fluid flow out of the cavity. The installation device may comprise a conduit for fluidly connecting the outlet to a remote location. The installation device may comprise a plurality of conduits (e.g. one per outlet). The or each conduit may, for example, be a pipe, tube, riser, etc. The or each conduit may be a flexible conduit.

The remote location may be for example, a location that is at lower pressure than the location of the cell body. As an example, the remote location may be above the free surface of the body of water. That is, the remote location may be at atmospheric pressure. Thus, the conduit may be sufficiently long to permit fluid communication between the device and atmosphere when the device is at (or proximate to) the depth of the cell body. The conduit may have a length that is greater than 2 m, or greater than 5 m, or greater than 10 m, or greater than 15 m.

The installation device may comprise closure means for releasably closing the or each outlet. The closure means may e.g. be in the form of a cap, bung or a valve provided for the or each outlet. The closure means may be disposed in or adjacent to the or each outlet of the cavity or may be provided in or adjacent to an outlet of the or each conduit.

The installation device may comprise a pump for moving fluid from the cavity (e.g. through the outlet). This may avoid the need for a conduit that is capable of extending to a location with atmospheric pressure. Instead, the pump may be configured to discharge fluid from the cavity to draw the working surface into the cavity.

The opening of the cavity may be shaped for receipt of the peripheral lip of a cell body (i.e. the entire peripheral lip) such that, when the working surface is drawn into the cavity it may be positioned over and around the peripheral lip.

The installation device may comprise a plurality of mounting portions configured for releasable mounting of a working surface. The or each mounting portion may e.g. be a hook, anchor, magnetic arrangement, releasable lock, clamp, etc.

The opening of the installation device may be substantially obround.

The working surface may be as described above with respect to the first aspect. For example, the working surface may be a membrane (e.g. an elastic membrane).

In a seventh aspect there is provided a method of installing a working surface on a submerged cell body, the method comprising:
providing a portable installation device comprising a body defining a cavity and an opening to the cavity, and an outlet arranged for fluid flow out of the cavity when a working surface seals the opening;
mounting a working surface to the installation device so as to seal the opening to the cavity;
lowering the installation device to the cell body; and
discharging fluid from the cavity through the outlet to draw the working surface into the cavity;
mounting the working surface to the cell body so as to extend across an opening of the cell body.

The method may comprise closing the outlet of the body. The method may comprise maintaining the outlet in a closed configuration while lowering the installation device. The step of mounting the working surface to the cell body may comprise opening the outlet.

In other embodiments, the outlet may be maintained in an open configuration while lowering the installation device. In this respect, discharging fluid from the cavity may be performed concurrently with the step of lowering the installation device. That is, the submergence of the body may result in discharge of fluid from the cavity through the outlet. In particular, this may result from a pressure difference across the working surface (i.e. the cavity having a lower pressure than that externally of the working surface).

Mounting the working surface to the cell body may comprise positioning the working surface over and around at least a portion of the cell body (e.g. a peripheral lip of the cell body). Mounting the working surface to the cell body may comprise engaging mounting portions of the workings surface with corresponding mounting portions of the cell body. Such engagement may be performed while the working surface is mounted to the installation device. Thus, the working surface may be engaged/mounted to the cell body and installation device concurrently.

The method may further comprise disconnecting the working surface from the installation device.

The method may further comprise raising the installation device (i.e. with the working surface disconnected and mounted to the cell body).

The portable installation device may be as described in the sixth aspect.

The invention includes the combination of the aspects and preferred features described except where such a combination is clearly impermissible or expressly avoided.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### SUMMARY OF THE FIGURES

So that the invention may be understood, and so that further aspects and features thereof may be appreciated, embodiments illustrating the principles of the invention will now be discussed in further detail with reference to the accompanying figures, in which:

FIG. 1 is a perspective view of a first embodiment of a WEC system;

FIG. 2 is a perspective view of a second embodiment of a WEC system;

FIGS. 3A and 3B are end views of a third embodiment of a WEC system;

FIG. 3C is a perspective view of the third embodiment of the WEC system;

FIG. 4 is a schematic view of a connection between a WEC module and system according to a first embodiment;

FIG. 5 is a schematic view of a connection between a WEC module and system according to a second embodiment;

FIGS. 6A and 6B are schematic views of a connection between a WEC module and system according to a third embodiment;

FIGS. 7A and 7B are schematic views of a connection between a WEC module and system according to a fourth embodiment;

FIGS. 8, 9 and 10 are schematic views of blanking arrangements according to various embodiments;

FIGS. 11 and 12 are schematic views of drainage arrangements according to first and second embodiments;

FIGS. 13, 14 and 15 are schematic views of debris separation according to three embodiments;

FIGS. 16A and 16B are schematic views showing mounting of a WEC module to a base structure according to a first embodiment;

FIGS. 17A and 17B are schematic views showing mounting of a WEC module to a base structure according to a second embodiment;

FIG. 18 is a schematic view showing mounting of a WEC module to a base structure according to a third embodiment;

FIG. 19 is a schematic view showing mounting of a WEC module to a base structure according to a fourth embodiment;

FIGS. 20 and 21 are respective exploded and detailed views of a WEC system according to a fourth embodiment;

FIGS. 22A and 22B are respective side and front views of a WEC module according to a fifth embodiment;

FIG. 23A to 23H are views depicting a process for deploying a WEC module to a base structure;

FIG. 24A is a sectional view of a WEC system according to a sixth embodiment;

FIG. 24B is a perspective view of a support frame of the WEC system of the sixth embodiment;

FIGS. 25A and 25B are schematic views illustrating installation of a working surface by an installation device; and

FIGS. 26A to 26D illustrate seventh, eighth, ninth and tenth embodiments of a WEC module.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

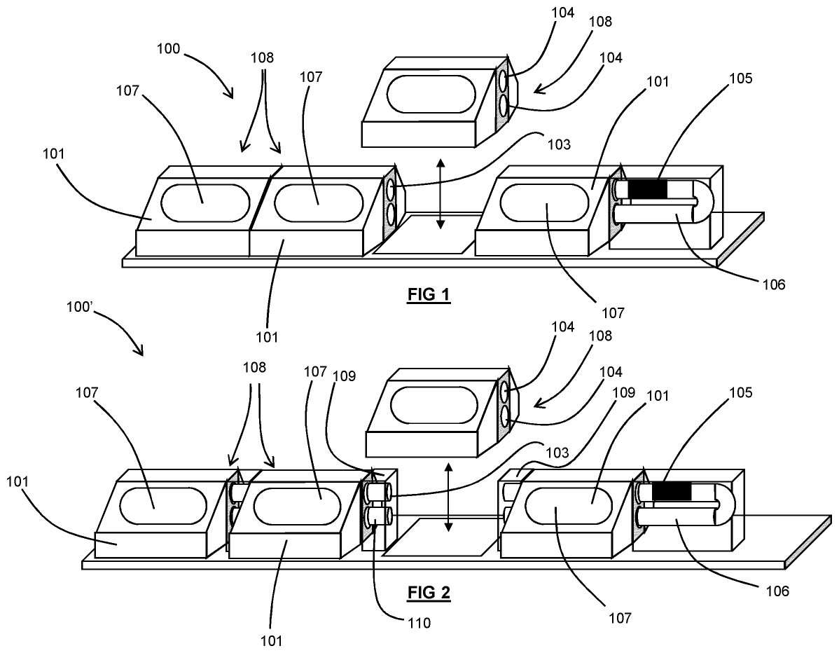

FIG. 1 illustrates a wave energy conversion (WEC) system 100 that is configured to be submerged in a body of water. The system 100 comprises a plurality of modular WEC cells 101 mounted to a base structure 102. In particular, each cell 101 forms part of a module 108 that mounts to the base structure 102. Each module 108 includes two cells 101 in a back-to-back arrangement. The system 100 comprises a fluid flow path 103 that is partly defined by the cells 101 (or modules 108) and partly defined by the base structure 102. That is, each module 108 comprises two vertically spaced corresponding cell duct portions 104 formed therein, such that when the modules 108 are mounted to the base structure 102, the cell duct portions 104 align to form two continuous linear ducts.

The base structure 102 comprises an energy converter, in the form of a turbine 105. This turbine 105 is disposed in a U-shaped duct portion 106 that forms part of the base structure 102. Openings of the U-shaped duct portion 106 align with corresponding openings of the duct portions 104 of the adjacent (end) module 108. In this way, the U-shaped duct portion 106 of the base structure 102 connects the two linear ducts formed by the mounted modules 108. Thus, the fluid flow path 103 is formed by the combination of the cell duct portions 104 and the U-shaped duct portion 106.

Each cell 102 comprises a cell body 133 and a working surface in the form of a membrane 107 that extends across an opening that is formed in the cell body 133. The membrane 107 is mounted at a sloped portion of the cell body 133 so as to be angled away from a vertical orientation. Although not apparent from the figure, the cell body 133 and the membrane 107 define a chamber that contains a working fluid. This chamber of each cell 102 is in fluid communication with the fluid flow path 103, such that when the membrane 107 flexes in response to wave motion it drives air from the chamber and into the fluid flow path 103. In this way, working fluid is moved along the fluid flow path 103 to the turbine 105 (by movement of the membranes 107) so as to cause rotation of the turbine 105, which generates electricity.

FIG. 2 illustrates a variation of the system 100 shown in FIG. 1. The system 100′ again includes a plurality of WEC cells 101 mounted to a base structure 102. In the presently illustrated system, however, the cells 101 are separated from one another via mounting blocks 109 that form part of the base structure 102 (protrude upwardly from a planar slab of the base structure 102) and that are located intermediate each of the modules 108. Each mounting block 109 comprises intermediate duct portions 110 that align and seal with the duct portions 104 of the modules 108, so as to form the fluid flow path 103.

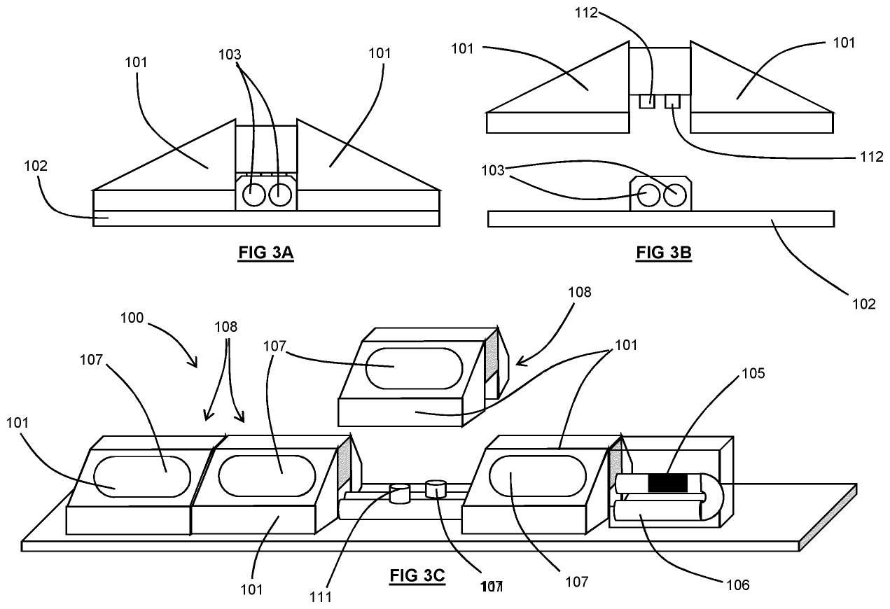

In the embodiments of FIGS. 1 and 2, when one module 108 is removed from the system 100, 100′ the fluid flow path 103 is interrupted (i.e. the portion of the fluid flow path 103 defined by the module 108 is removed). In the variation shown in FIGS. 3A, 3B and 3C, that is not the case.

In the system 100″ of FIGS. 3A-3C, the base structure 102 comprises a complete fluid flow path 103 defined by a duct 106 that extends comprises two legs extending centrally along the base structure 102 that are connected by a U-shaped portion in which the turbine 105 is disposed. The duct 106 comprises a plurality of openings 111 spaced therealong that fluidly connect with the cell chambers when the modules 108 are mounted to the base structure 102. In particular, each module 108 comprises two fluid exchange ports 112 that interface with the openings 111 of the duct 106 so as to create a sealed path for fluid exchange between the cell chambers and the fluid flow path 103. In particular, each module 108 is positioned over the top of the duct 106 of the base structure 102 and the ports 112 engage the openings 111 of the duct 106. The nature of this connection will be described further below.

As the fluid flow path 103 is fully defined by the base structure 102, removal of a module 108 from the base structure does not interrupt the fluid flow path 103. In this way, the system 100″ is able to operate regardless of whether a module 108 has been removed (e.g. for repair or maintenance). As should be appreciated, in the above described (and illustrated) embodiments, each module 108 comprises two cells 101. In other embodiments, however, each module 108 may comprise a single cell 101 (such that the cell 101 itself is a module 108).

FIGS. 4 to 7B provide various exemplary embodiments of how a cell 101 (or module 108) may be sealed to the fluid flow path 103 which, although not shown, may form part of a base structure such as one of those described above. In each of these embodiments, the cell 101 comprises a fluid exchange port 112 for exchange of working fluid with the fluid flow path 103. This fluid exchange may be in the form of discharge of working fluid from the chamber of the cell 101, receipt of fluid into the chamber from the fluid flow path 103, or both discharge and receipt of working fluid (i.e. depending on the movement of the membrane 107).

In the embodiment of FIG. 4, the fluid exchange port 112 comprises a module sealing face 113 in the form of a planar surface. The module sealing face 113 is substantially annular, so as to extend about an opening of the fluid exchange port 112. Upon mounting of the cell 101 to e.g. a base structure, the module sealing face 113 interfaces with a corresponding duct sealing face 114 that forms part of an opening 111 to a duct 106 defining the fluid flow path 103. Both sealing faces 113, 114 are parallel to one another and extend in respective planes that are generally perpendicular to fluid flow through the fluid exchange port 112.

A deformable sealing member 115 is mounted to the module sealing face 113. Thus, when the sealing faces 113, 114 are brought together (i.e. when a cell is engaged with the fluid flow path 103), the sealing member 115 is sandwiched between the sealing faces 113, 114. This facilitates sealing between the cell 101 and the fluid flow path 103, so as to prevent fluid ingress therein.

In order to further facilitate this sealing between the cell 101 and the fluid flow path 103, the cell comprises a moveable portion 116. The module sealing face 113 forms part of this moveable portion 116, which is moveable along an adjustment axis that is generally parallel to fluid flow through the fluid exchange port 112, and perpendicular to the sealing faces 113, 114. The moveable portion 116 has a circumferential section 117 that extends circumferentially about the fluid exchange port 112, and a radial section 118 that extends radially from a distal end of the circumferential section 117. The module sealing face 113 forms an outer surface of this radial section 118. The circumferential section 117 snugly fits about the port 112, such that it is in sliding contact with an outer surface of the fluid exchange port 112. Any gap between the port 112 and the moveable portion 116 is sealed by annular sliding sealing rings 119 disposed therebetween.

The position of the moveable portion 116 is adjustable by way of an adjustment mechanism comprising a plurality of circumferentially spaced threaded rods 120 and corresponding fasteners 121 engaged therewith. Each rod 120 projects rearwardly (i.e. away from the sealing faces 113, 114) from the radial section 118 of the moveable portion 116 and through a corresponding aperture formed in a radially projecting flange 122 of the fluid exchange port 112. In this way, adjustment of the position of the fasteners 121 with respect to each rod 120 alters the axial position of the moveable portion 116 with respect to the fluid exchange port 112. In this way, the axial position of the module sealing face 113, with respect to the port 112, can be adjusted.

FIG. 5 illustrates a similar embodiment to that shown in FIG. 4 and therefore corresponding reference numerals have been used. This embodiment only differs in that the deformable sealing member 115′ is tubular so as to contain an internal (ring-shaped) cavity 123. In this embodiment the sealing member 115′ may be inflated by introducing fluid into the cavity 123. Inflation of the sealing member 115′ ensures that any gap between the sealing faces 113, 114 is sealed by the sealing member 115′.

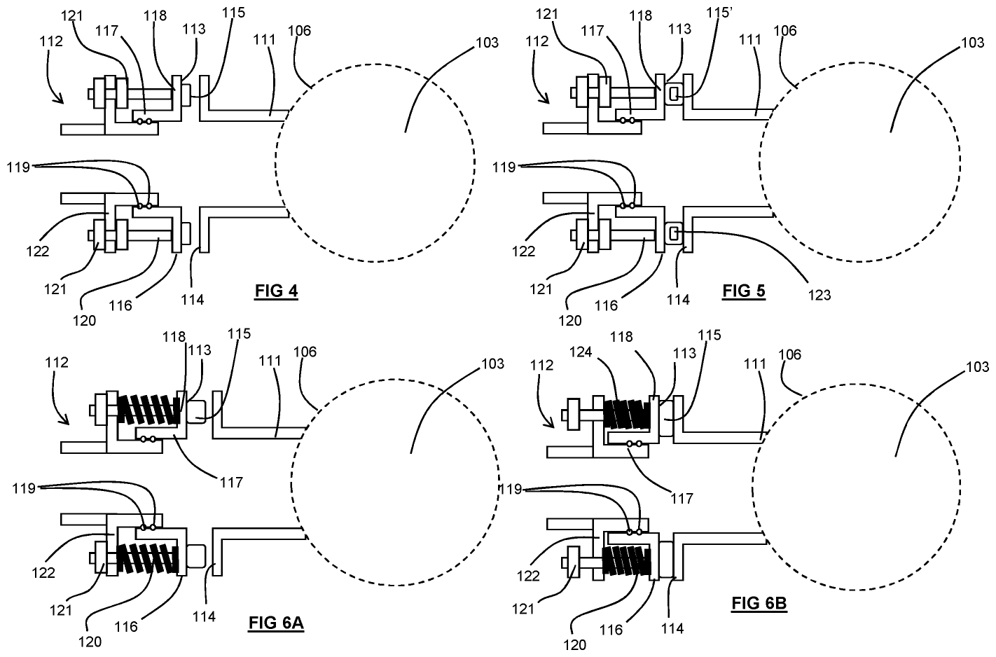

FIGS. 6A and 6B illustrate a further embodiment that, again, has similar features to those described above. This embodiment differs, however, in that the moveable portion 116 is biased in a direction away from the flange 122 by way of a plurality of compression springs 124 that surround each rod 120 and extend between the port flange 122 and the radial section 118 of the moveable portion 116. Further, rather being held in place by the fasteners 121, the rods 120 are allowed to move freely through the apertures formed in the flange 122.

As such, when the sealing faces 113, 114 are brought together (as shown in FIG. 6B), the force moves the moveable portion 116 towards the flange 122 against the biasing force of the spring 124 (i.e. until the force of the spring 124 matches that bringing the sealing faces 113, 114 together). The force of the spring 124 helps to increase the sealing force between the sealing faces 113, 114. As should be appreciated, the inflatable sealing member 115′ of FIG. 5 could be used in this arrangement.

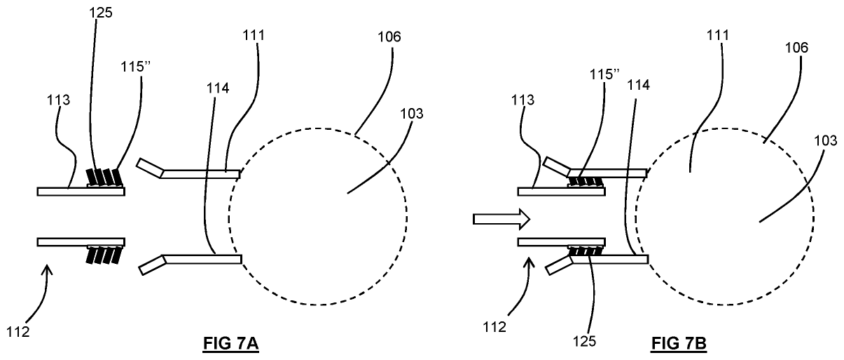

The embodiment shown in FIGS. 7A and 7B differs from the above described arrangements in that it comprises circumferential, rather than planar, sealing faces 113, 114. In this embodiment, the distal end of the fluid exchange port 112 is received (as shown in FIG. 7B) within the interior of the opening 111 of the duct 106, so as to be surrounded by the opening 111 of the duct 106. A deformable sealing member 115′″, in the form of a piston seal, is mounted to the cell sealing surface 113 so as to extend circumferentially about the sealing surface 113. The sealing member 115″ comprises a plurality of radially extending and axially spaced ribs 125 that extend across the gap formed between the sealing faces 113, 114. Each rib 125 is inclined from the radial direction so as to extend slightly rearwardly (away from the distal end of the port 112). This facilitates receipt of the distal end of the port 112 into the duct opening 111. Receipt is also facilitated by a tapered entrance to the opening 111. In a variation of this embodiment, the piston seal may be inflatable (similar to that shown in FIG. 5.

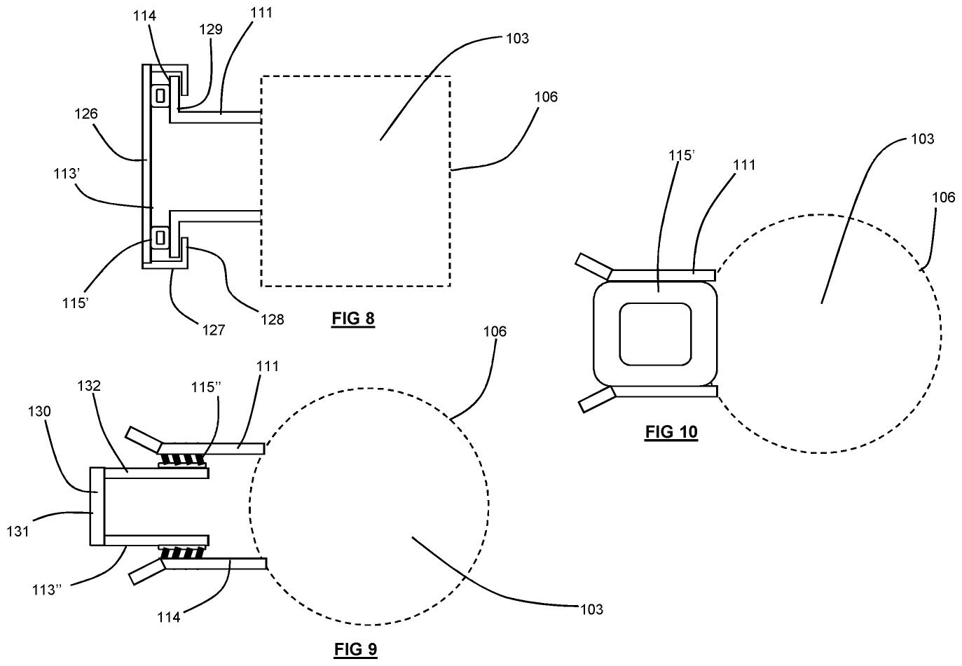

When a module 108 or cell 101 is detached from the base structure 102, it may be desirable to close or cover the opening 111 to the duct 106 to prevent the ingress of water into the duct 106 (and to allow continued operation of the system 100). FIGS. 8-9 provide exemplary embodiments of blanking devices for performing this function.

In FIG. 8, the opening 111 is closed by a cap 126. This figure is a top view of the cap 126 and duct 106. Whilst not immediately apparent from the figure, the cap 126 is fitted onto the duct opening 111 by sliding it downwardly over the opening 111. The cap 126 comprises a retaining lip 127 that extends partway about the periphery of the cap 126 (so as to allow sliding of the cap over the opening 111). The retaining lip 127 comprises a radially inwardly projecting rim 128 that engages a flange 129 of the opening 111 so as to retain the cap 126 on the opening 111. An inflatable sealing member 115′ is disposed on an inner sealing face 113′ of the cap so as to be sandwiched between the cap sealing face 113′ and a planar duct sealing face 114 when the cap is in the engaged position. Inflation of the sealing member 115′ causes it to fill any gap between the sealing faces 113′, 114 and also moves the rim 128 of the retaining lip 127 against the flange 129.

In FIG. 9, a further embodiment is shown in which a plug 130, instead of a cap, is used to close the opening 111 to the duct 106. The plug 130 is cup-shaped so as to have a circular base 131 and a sidewall 131 (in the form of a tube) projecting from the base 131. An outer circumferential surface of the sidewall 131 defines a plug sealing surface 113″ that faces an inner circumferential sealing surface 114 of the duct opening 111. A sealing member 115′ is mounted to the plug sealing surface 113″ for sealing with the duct sealing surface 114. The sealing member 115″ is substantially the same as that shown in FIGS. 7A and 7B. Once the plug 130 is inserted into the opening 111 it relies on friction between the sealing member 115″ and the duct sealing surface 114, and any pressure difference (between the fluid flow path 103 and the external environment), in order to be retained in the opening 111.

FIG. 10 also illustrates a plug, which in this case is in the form of an inflatable sealing member 115″. This sealing member 115″ is configured such that, when in an inflated configuration, it extends across the entire opening 111 so as to block the opening and prevent water ingress into the fluid flow path 103 (or the escape of fluid from the fluid flow path 103).

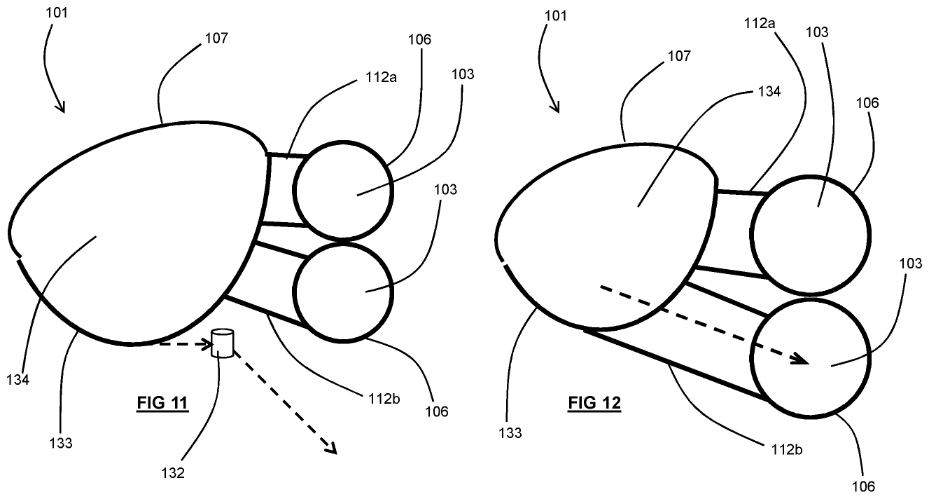

Even with the provision of seals, caps and plugs, there is still the possibility of the ingress of unwanted fluid (such as water) into each cell 101 of the system 100. FIGS. 11 and 12 illustrate two arrangements that may facilitate removal of this fluid from a cell 101.

In FIG. 11, the cell 101 comprises a sump 132 that is fluidly connected to a low-point of the chamber 134 defined by the membrane 107 and the cell body 133 of the cell 101 (the sump 132 may alternatively be disposed at the low-point of the chamber 134). This means that water in the chamber 134 will flow to, and be collected in, the sump 132. The sump 134 may comprise a pump for discharge of the water from the system 100. It's worth noting that in the illustrated embodiment, the cell 101 comprises two fluid exchange ports in the form of an inlet 112a and an outlet 112b.

The embodiment of FIG. 12 differs in that it does not comprise a sump. Rather, the outlet 112b of the cell 101 is fluidly connected to the chamber 134 at the low-point of the chamber 134. Thus, any water in the chamber 134 will flow from the chamber 134 via the outlet 112b to the fluid flow path 103. The duct 106 defining the fluid flow path 103 may be provided with a pump for discharging water from the fluid flow path 103. In this way, (and unlike the embodiment of FIG. 11) only one pump may be required to discharge the water received from all of the cells 101 of the system 100.

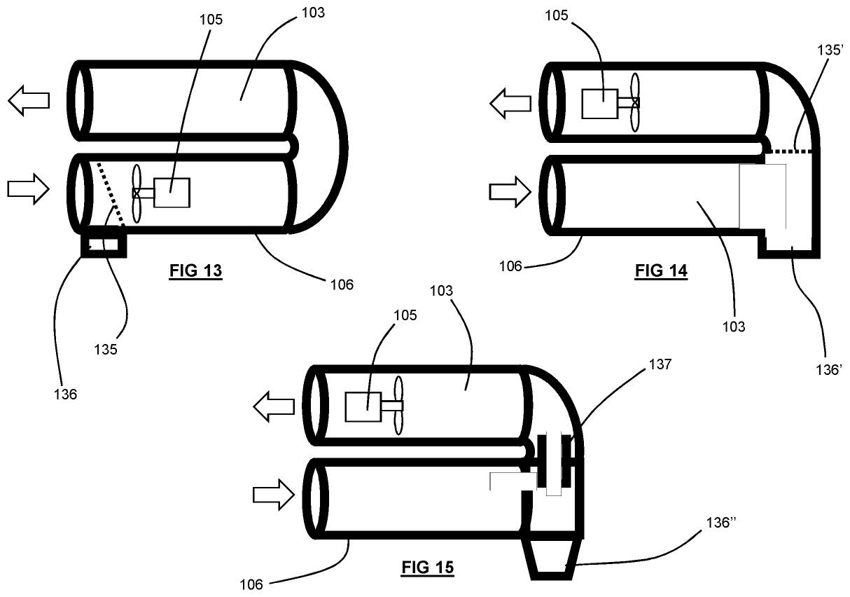

A further issue that may be faced by the WEC system 100 is debris that enters the fluid flow path 103, which may reduce the efficiency of the system 100 and/or may cause damage to various components of the system (such as the turbine 105). FIGS. 13 to 14 provide exemplary arrangements for managing debris in the WEC system.

FIG. 13 illustrates a portion of the duct 106 of the system 100 that comprises the turbine 105. The duct 106 comprises a debris separator that is upstream of the turbine 105. The debris separator comprises a grille 135 that extends across the interior of the duct 106 and a debris trap 136 in the form of a recess positioned upstream of the grille 135. The grille 135, trap 136 and turbine 105 are disposed in a substantially horizontal portion of the duct 106. The grille 135 extends on an incline across the duct 106 such that a lower end of the grille 135 is further downstream than an upper end of the grille 135. The result of this arrangement is that the grille 135 partially overhangs the debris trap 136. Thus, debris that is blocked by the grilled 135 may fall (due to gravity) into the debris trap 136.

The embodiments in FIG. 14 also includes a grille 135′ and a debris trap 136′. Again, both the grille 135′ and the debris trap 136′ are upstream of the turbine 105. In this embodiment, however, the grille 135′ is disposed in a vertical portion of the duct 106 and extends substantially horizontally across the interior of the duct 106. The debris trap 136′ is located directly below the grille 135′ such that debris that is caught by the grille 135′ falls into the debris trap 136′.

In FIG. 15, the embodiment comprises a centrifugal separator 137 instead of a grille. The centrifugal separator 137 is oriented vertically and disposed in a vertical portion of the duct 106. As should be appreciated, the centrifugal separator 137 is configured such that working fluid passes through an upper outlet thereof (so as to continue flowing through the duct 106), whilst debris is discharged through a lower opening of the centrifugal separator 137 (into a debris trap 135″).

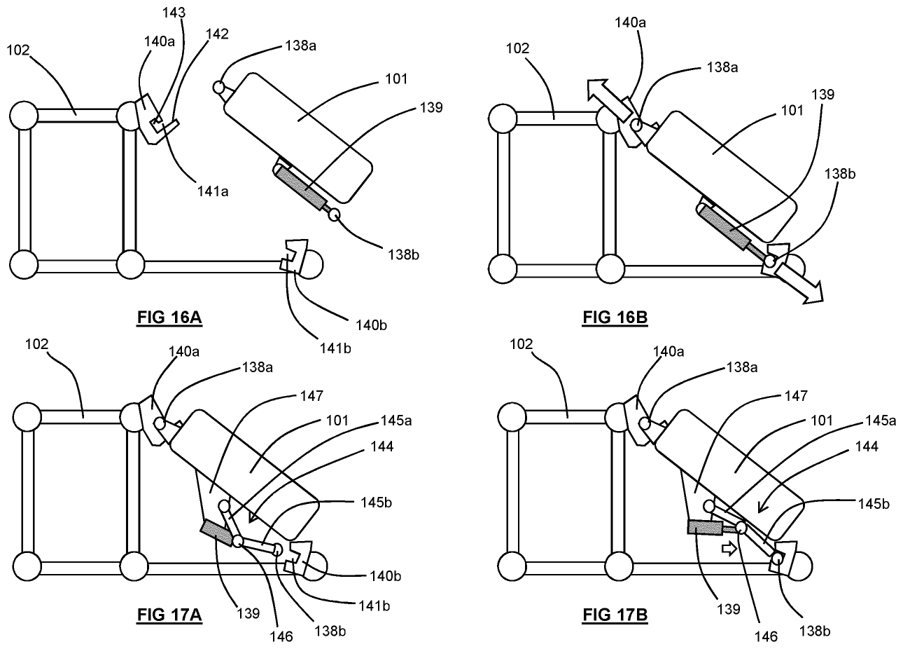

FIGS. 16A and 16B illustrate engagement of a cell 101 with a base structure 102 according to a first embodiment. The cell 101 and base structure 102 are illustrated schematically and thus, for example, the fluid flow path or duct of the base structure 102 are not shown (nor is the fluid connection between the cell 101 and the base structure 102).

The cell 101 comprises a first mounting portion 138a, which is in the form of a substantially horizontally extending pin and is located at an upper end of the cell 101. The cell 101 also comprises a second mounting portion 138b positioned at a lower end of the cell 101 and connected to the cell 101 by an actuator in the form of a hydraulic ram 139. A proximal (upper) end of the ram 139 is mounted to a central portion of the underside of the cell 101 and an opposing distal end of the ram 139 forms the second mounting portion 138b, which is also in the form of a horizontally extending pin.

The base structure 102 comprises, at an upper end thereof, a first receiving portion 140a, which is hook-shaped and defines a hook-shaped first recess 141a into which the first mounting portion 138a of the cell 101 may be received. The base structure 102 also comprises a second receiving portion 140b that defines a second recess for receipt of the second mounting portion 138b of the cell 101. The first receiving portion 140a is positioned so as to be above and rearward (i.e. away from the cell 101) with respect to the second receiving portion 140b.

As is illustrated by FIG. 16B in particular, to mount the cell 101 to the base structure 102, the cell 101 is moved such that the first mounting portion 138a is received in the hook-shaped recess 141a. The hook shape of the first receiving portion 140a aids in guiding the first mounting portion 138a into the recess 141a. That is, a lower projection 142 of the hook-shape extends in a forward direction (towards the cell 101) in an inclined manner, such once the first mounting portion 140a is received on an upper surface of the projection 142, the incline of the projection 142 means that the first mounting portion 140a will be guided (e.g. by the projection 142 and gravity) further into the recess 141a.

Once the first mounting portion 138a is received in the hook-shaped recess 141a, the cell 101 is further moved (e.g. lowered) such that the second mounting portion 138b is proximate the second recess 141b (of the second receiving portion 140b). The hydraulic ram 139 is then extended so as to move the second mounting portion 138b into the second recess 141b. Further extension of the hydraulic ram 139 causes the second mounting portion 138b to contact an end of the second recess 141b and continued extension from this point causes the cell 101 to move away from the second mounting portion 138b and the second receiving portion 140b. When this occurs, the first mounting portion 138a moves further into the hook-shaped recess 141a. Due to the hook shape of the recess 141a, an end of the recess 141a defines a locking region 143 that restricts movement of the first mounting portion 138a out of the recess 141a.

Thus, once the first mounting portion 138a is received in the locking region 143 the cell 101 is locked (i.e. fully mounted) to the base structure 102.

The embodiment of FIGS. 17A and 17B is similar to that described above and therefore corresponding reference numerals have been used. This embodiment differs, however, in that the second mounting portion 138b is disposed at a distal end of an over-centre mechanism 144 for locking the second mounting portion 138b in position. The over-centre mechanism 144 comprises first 145a and second 145b linkages that are connected to one another at a central pivot point 146. The first linkage 145a is coupled at a proximal end (proximate the cell 101) to a coupling plate 147 projecting downwardly from an underside of the cell 101. The second mounting portion 138b is mounted at a distal end (distal from the cell 101) of the second linkage 145b. A hydraulic ram 139 is coupled, at one end, to the coupling plate 147 and at the end to the central pivot point 146 of the linkages 145a, 145b.

The operation of the over-centre mechanism 144 is apparent from FIG. 17B in particular. As the hydraulic ram 139 is extended, the second linkage 145b is moved such that the second mounting portion 138b is moved into the second recess 141b. Further extension of the ram 139 results in the linkages 145a, 145b becoming parallel and then subsequently will pivot so as to be “over-centre” (as shown in FIG. 17B). The over-centre mechanism 144 may, for example, be provided with a stop in order to limit further extension of the ram 139 (i.e. beyond the over-centre position). The over-centre position thus represents a stabled locked position so as to maintain the cell 101 in a mounted state with the base structure 102.

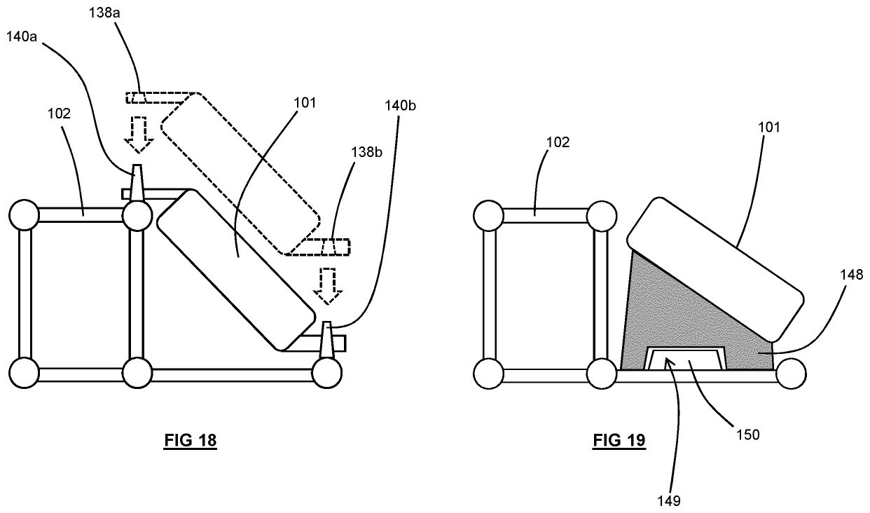

In FIG. 18, the cell 101 again comprises first 138a and second 138b mounting portions. These are, however, in the form of apertures rather than pins (as was the case with the previously described embodiments). The base structure 102 comprises corresponding first 140a and second 140b receiving portions in the form of vertically extending tapered pins. The tapered shape of the pins facilitates engagement of the receiving portions 140a, 140b with the mounting portions 138a, 138b. In a variation of this embodiment, the pins may be provided on the cell 101 and apertures (for receipt of the pins) may be provided on the base structure 102.

In FIG. 19, the cell 101 comprises a ballast weight 148 that has sufficient mass to secure the cell 101 with respect to the base structure 102. The ballast weight 148 comprises a recess 149 formed in an underside thereof. The recess 149 engages a corresponding protrusion 150 of the base structure to further facilitate the restriction of movement of the cell 101 relative to the base structure 102.

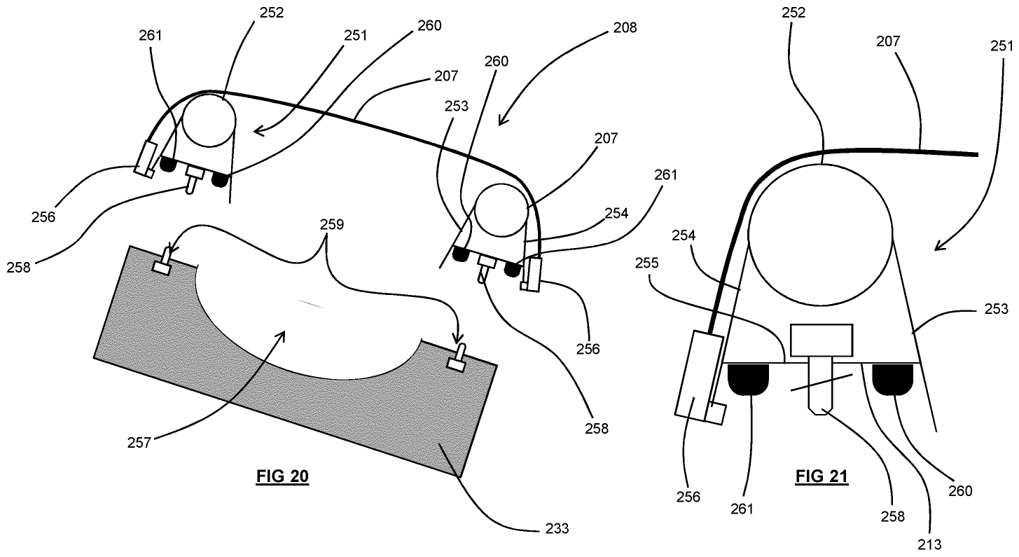

In the embodiments discussed above, the module 108 comprises one or more cells 101, each having a cell body 133 that, along with a membrane 107 defines a chamber 134 for storing a working fluid. An alternative arrangement to this is depicted in FIGS. 20 and 21.

As is apparent from FIG. 20, in this system 200 the module 208 (i.e. the modular part of the system 200) comprises a membrane 207 and a support frame 251, across which the membrane 207 is stretched. The support frame 251 is formed of an aperture tube 252 that extends in an obround shape and defines an obround aperture across which the membrane 207 is stretched, an inner skirt 253 depending from an inner (aperture-facing) side of the aperture tube 252, and an outer skirt 254 depending from an opposing outer side of the aperture tube 253. A base plate 255 extends transversely between the inner 253 and outer 254 skirts and, as will be explained further below, a lower surface of the base plate 255 defines a sealing surface 213 of the module 208. The support frame 251 may be formed of steel and the components of the support frame 251 may be welded together to form the support frame 251.

An outer edge of the membrane 207 is clamped to a lower edge the outer skirt 254 by way of a plurality of clamps 256 that are spaced about the support frame 251.

The module 208 is configured to engage with a cell body 233 that may form part of a base structure (not shown). The cell body 233 may be formed of e.g. steel or concrete and comprises a recess 257 that, together with the membrane 207, defines a chamber for working fluid (when the module 208 is mounted to the cell body 233).

To facilitate the mounting, module 208 comprises mounting portions in the form of a plurality of locks 258 that are spaced along the base plate 255 of the support frame 251. Each lock 258 may, for example, be in the form of a twist lock that can be rotated in and out of a locked position. The cell body 233 comprises receiving portions in the form of a plurality of locking holes 259 formed therein that are each arranged for receipt of a corresponding lock 258 of the module 208. Thus, to mount the module 208 to the cell body 233, the module 208 can be manoeuvred such that the locks 258 are received in the locking holes 259. The locks 258 can then be actuated so as to enter a locked position, in which the module 208 is retained with respect to the cell body 233.

The module 208 further comprise inner 260 and outer 261 sealing members that extend along the sealing surface 213 such that each forms a complete loop. When the module 208 is mounted to the cell body 233, the sealing members 260, 261 are sandwiched between the base plate 255 and the cell body 233. This seals between the chamber (formed between the cell body 233 and the membrane 207) and the external environment.

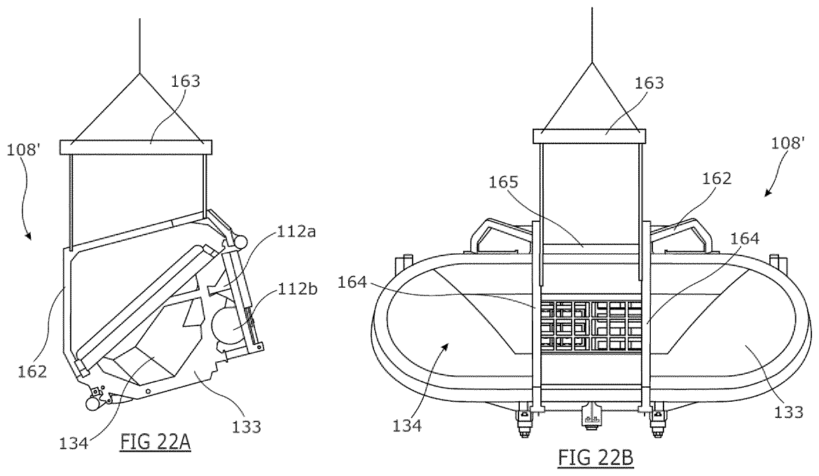

FIGS. 22A and 22B depict a further module 108′ that is of the type discussed above with respect to FIGS. 1 to 19. The module 108′ comprises a cell body 133 shaped so as to form a chamber 134 and an aperture that may be sealed by a membrane (not shown). The module 108′ comprises an (upper) inlet fluid exchange port 112a and a (lower) outlet fluid exchange port 112b to provide a sealed fluid connection between the chamber and a fluid flow path of a WEC system.

The module 108′ additionally comprises a handling frame 162 that provides a connection point for a handling tool, which in the present case is in the form of a winch 163. The handling frame 162 comprises two laterally spaced U-shaped frame elements 164 that are connected by a transversely extending cross-beam 165. Each frame element 164 extends from a connection at an upper lip of the cell body 133 to an opposing connection at a lower lip of the cell body 133. A central portion of each frame element 164 is spaced above the cell body 133 so as to provide for attachment of the winch 163. The handling frame 162 provides an additional function in that it acts to limit expansion of the membrane (not shown), which may avoid damage to the membrane.

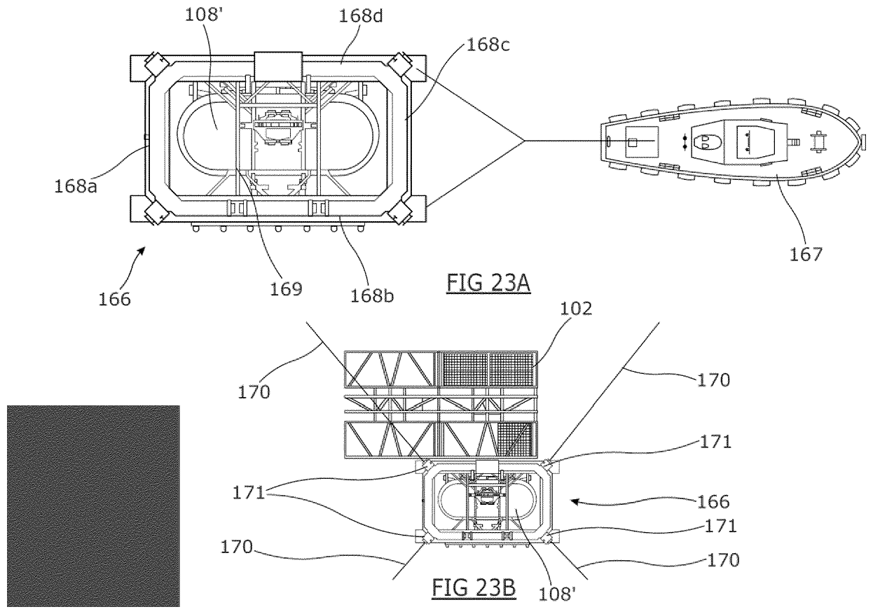

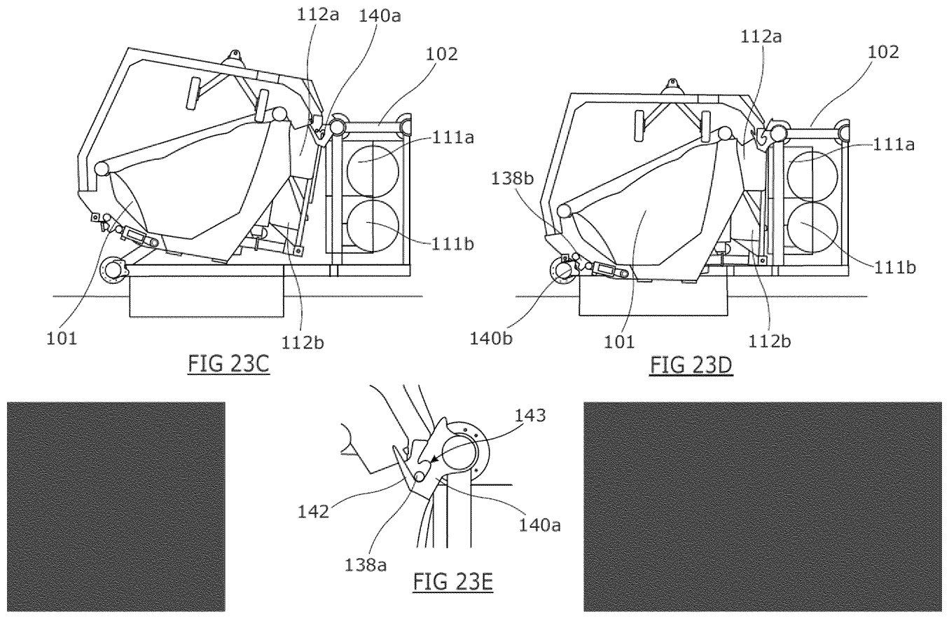

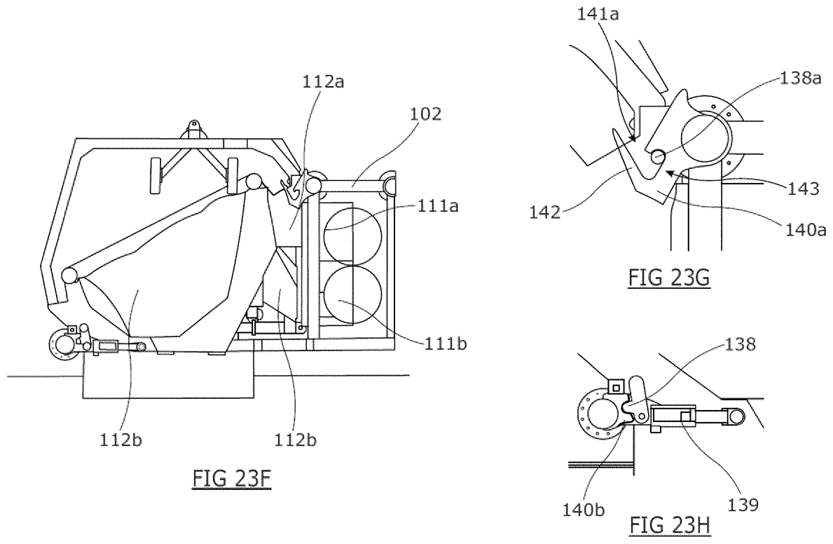

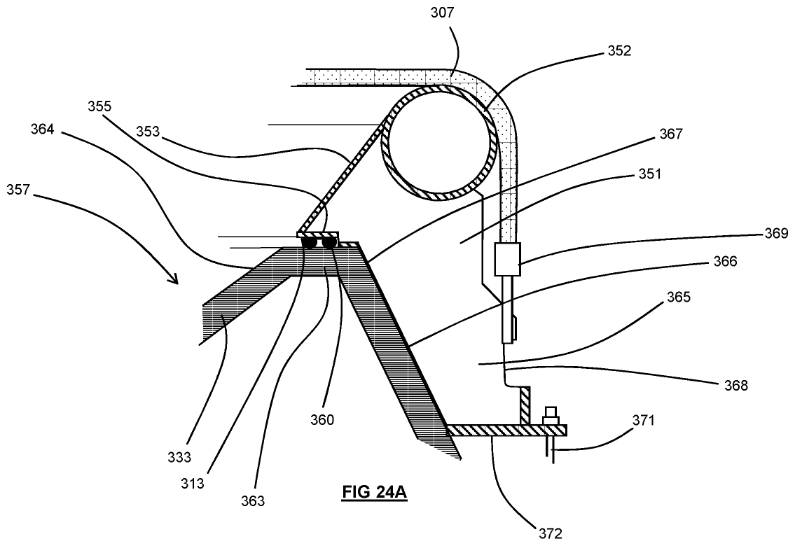

Deployment of the module 108′ shown in FIGS. 22A and 22B is illustrated in FIGS. 23A to 23H.

FIG. 23A shows the module 108′ suspended from a buoyancy tool in the form of a deployment barge 166. In particular, the module 108′ is suspended from a winch (not shown) that is mounted to a gantry 169 of the barge 166. The combination of the winch and the gantry 169 provides manoeuvrability of the module 108′ by the barge 166 along three axes.

The deployment barge 166 is being towed by a towing vessel 167. The barge 166 is formed of four elongate hull portions 168a, 168b, 168c, 168d forming a rectangular shape so as to define a rectangular aperture therebetween. The shape of the barge 166 (i.e. the provision of the four elongate hulls 168a, 168b, 168c, 168d) is such that it has a reduced water plane area compared to the towing vessel 167. As such, the barge 166 has a dynamic response in waves that is less than that of the vessel 167. This reduces the differential movement between the lifting points and the module 108′, which reduces dynamic winch cable loads.

In FIG. 23B, the barge 166 is located at the site of the base structure 102, to which the module 108′ is to be mounted. The base structure 102 is positioned on the seabed below the barge 166, which is floating on the sea surface. The barge 166 is connected to four spaced apart mooring points (not shown) via mooring lines 170. Each mooring line 170 extends from a corresponding mooring winch 171 mounted to the barge 166. In particular, each hull intersection comprises a mooring winch 171 such that the four mooring winches 171 are mounted at the corners of the barge 166. The winches 171 are then controlled to move the barge 166 into the desired position above the base structure 102.

In FIG. 23C, the module 108′ has been lowered to the base structure 102 by the winch (not shown). As is shown in more detail in FIG. 23, the module 108′ has been manoeuvred (by movement of the winch on the gantry 169 of the barge 166) such that a first mounting portion 138a (in the form of a pin) at an upper rearward portion of the module 108′ is received in the recess 141a of a first receiving portion 140a of the base structure 102. This receipt is facilitated by a lower projection of the first receiving portion 140a, which defines an inclined guide surface 142 to guide the first mounting portion 138a into the recess 141a.

In FIG. 23D, the module 108′ has been lowered further by the winch. Due to the location of the first mounting portion 138a in the recess 141a of the first receiving portion 140a, the module 108′ has pivoted about that first mounting portion 138a. One result of this pivoting is that a second mounting portion 138b at a forward lower portion of the module 108′ is brought in proximity to a second receiving portion 140b of the base structure 102. Another consequence is that an electrical connector of the module 108′ (not shown) comes into contact with a wet mate connector (not shown) of the base structure 108′ such that an electrical power supply is provided to the module 108′. This connection also provides an indication that the module 108′ is seated on the base structure 102. Additional sensors may also be used to provide such an indication.

Additionally, the fluid exchange ports 112a, 112b of the module 108′ are brought into engagement with the duct openings 111a, 111b of a duct of the base structure 102 defining a fluid flow path (i.e. to a turbine of the base structure 102).

In FIG. 23F, subsequent to electrical power being supplied to the module 108′, a hydraulic ram 139 of the module 108′ is activated so as to be caused to move from a retracted position to an extended position. The second mounting portion 138b is mounted to a distal end of the hydraulic ram 139 such that, upon extension of the hydraulic ram 139, the second mounting portion 138b is moved into engagement with the second receiving portion 140b (as shown in FIG. 23H). Further movement of the ram 139, subsequent to this engagement, results in movement of the module 108′ in a rearward and upward direction as guided by the first mounting portion 138a in the recess 141a of the first receiving portion 140a. This causes the first mounting portion 138a to enter a locking region 143 of the recess 141a (as shown in FIG. 23G). The locking region 143 extends in an upward and rearward direction from the entrance of the recess 141a such that, upon location in the locking region 143, the first mounting portion 138a is prevented from moving laterally out of the recess 141a. In this way, the module 108′ is secured to the base structure 102, and a sealed fluid connection is provided between the chamber of the module 108′ and the duct of the base structure 102.

The winch may subsequently be disengaged from the module 108′ and retracted so as to complete deployment of the module 108′. A membrane may then be secured to the module 108′ (if not already secured thereto) and the chamber 134 of the module can be purged of any water located therein. As should be appreciated, the process may be reversed in order to remove the module 108′ from the base structure 102.

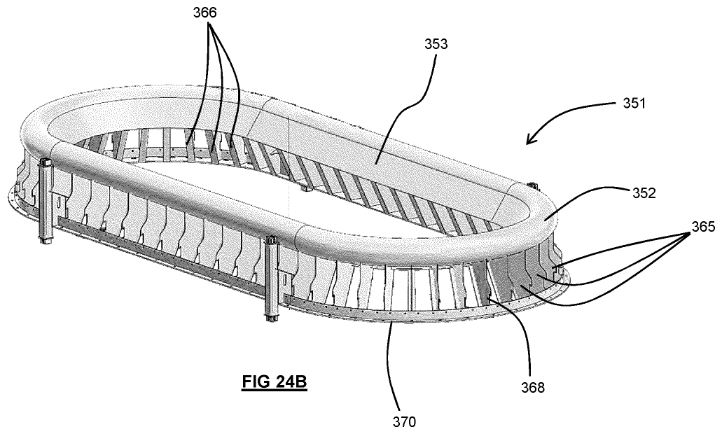

FIGS. 24A and 24B illustrate a further embodiment of a WEC system 300 that is configured such that a membrane 307 of the system lies in a substantially horizontal plane in normal use (although it should be appreciated that the membrane could lie on a slope with modification). This system 300 is similar to that shown in FIG. 20 in that module 308 comprises a support frame 351 and a working surface in the form of a membrane 307 but does not include a cell body 333. Instead, the cell body 333 forms part of a fixed structure that, in this embodiment, may be fixed to the seabed.

The profile of the cell body 333 is most apparent from FIG. 24A. The cell body 333 comprises a convex surface that defines a recess 357. This recess 357, together with the membrane 307, forms a chamber in which a working fluid may be stored in normal use. A peripheral lip 363 of the cell body 333 extends about (so as to surround) the recess 357. An inner circumferential surface 364 of the peripheral lip 363 partly defines the chamber and forms part of the convex surface defining the recess 357. An outer circumferential surface 367 of the peripheral lip 363 slopes downwardly and outwardly from an apex of the lip 363. Thus, the peripheral lip 363 tapers outwardly in a downward (or rearward) direction (i.e. in a direction of receipt of the module 308 in use).

The support frame 351, which is shown alone in FIG. 24B, comprises a ring member in the form of an aperture tube 352, which defines an aperture of the support frame 351 across which the membrane 307 extends (and seals in use). Although the aperture tube 352 has a tubular shape, it should be appreciated that it may take other forms that are not necessarily tubular.

A skirt 353 (which may be considered an inner skirt) depends from the aperture tube 352 (i.e. and extends for the entire circumference of the aperture tube). In particular, the skirt 353 is sloped in an inwardly and downwardly/rearwardly direction (i.e. in normal use). In this way, an internal space defined by the skirt 353 has an inverted frustoconical shape. The shape of the skirt 353 is such that it forms a generally continuous surface with the inner circumferential surface 364 of the cell body 333 (when the support frame 351 is mounted thereto). In this way, the skirt 353 partly defines the chamber for holding the working fluid.

A base member in the form of a base plate 355 projects outwardly from a lower end of the skirt 353 (i.e. for the entire circumference of the skirt). A lower surface of the base plate 355 defines a sealing surface 313 of the module 308. The base plate 355 rests on the peripheral lip 363 of the cell body 308 via a deformable sealing member 360 that is received between the base plate 355 and the peripheral lip 363. This provides the sealed connection between the module 308 and the cell body 333 (i.e. the sealing member 360 prevents leakage of fluid from (or into) the chamber). Thus, the portion of the interface between the cell body 333 and the support frame 351 located within the peripheral deformably sealing member 360 is sealed from water and, likewise, leakage of working fluid via the interface is prevented.

The support frame 351 also comprises a guide portion, which in the present embodiment is in the form of a plurality of webs 365 (or plates) depending from both the aperture tube 352 and the skirt 353. The webs 365 are spaced about the circumference of the support frame 351. Each web 365 comprises an inner edge 366 that is sloped outwardly and downwardly/rearwardly. The slope of the inner edge 366 is such that it complements the outer circumferential surface 367 of the peripheral lip 363. In this way, as the module 308 is lowered onto the cell body 333, the inner edges 366 of the webs 365 engage the outer circumferential surface 367 so as to guide the module 308 onto the cell body 333.

In addition to providing this guiding function, each web 365 also comprises a working surface retaining portion in the form of a notch 368. This notch 368 provides an attachment point for a corresponding mounting portion 369 of the membrane 307. That is, the membrane mounting portions 369 hook into each notch 368 so as to retain the membrane on the support frame 351. In particular, and as is illustrated, the membrane 307 extends over the curved circumferential outer surface of the aperture tube 352 and extends in a downward/rearward direction (where it is then connected to the support frame 351 by way of the mounting portion 369).

The support frame 351 also provides means for securing the module 308 to the cell body 333. In the present embodiment, that is in the form of a lower circumferential member 370 that extends about a periphery of the support frame 351 at lower ends of the webs 365. This lower circumferential member 370 comprises a plurality of circumferentially spaced apertures for receipt of hook member 371. Although not illustrated, these hook members engage with a corresponding circumferential portion of the cell body 333 to retain the module 308 on the cell body 333. As should be appreciated, other securing means may be used to secure the module 308 to the cell body 333, such as selective locking means. In other embodiments, for example, the mounting portion 369 of the membrane 307 may be secured to the cell body 333 once the support frame 351 is received on the cell body 333 (e.g. the mounting portion 369 may be disconnected from the support frame 351 and then reconnected on the cell body 333). In this way, the membrane 307 itself would retain the support frame 351 on the cell body 333.

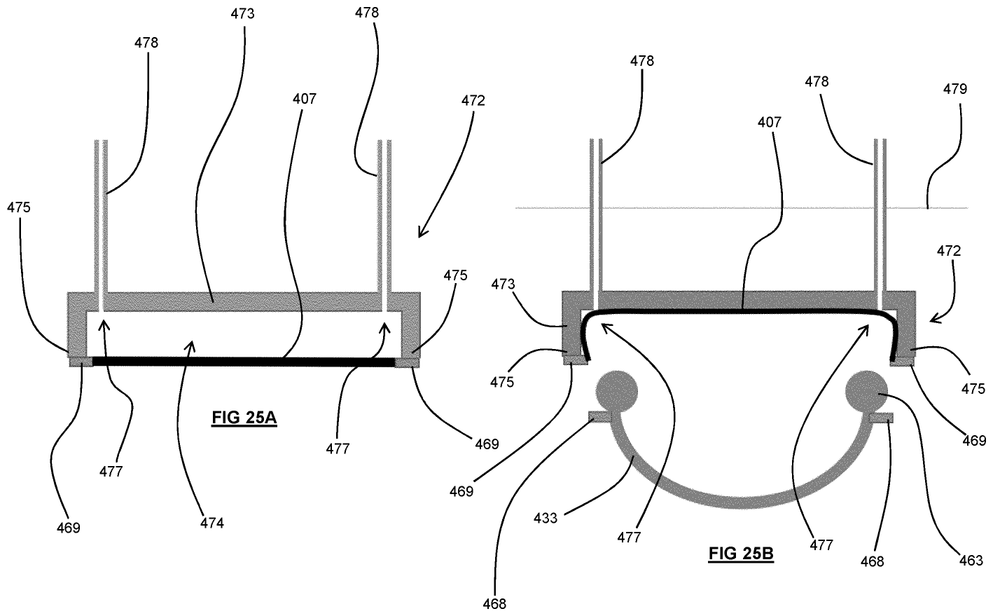

FIGS. 25A and 25B illustrate a portable installation device 472 for installing a membrane 407 on a submerged cell body 433. The installation device 472 comprises a body 473 defining a cavity 474 having an opening, and a plurality of mounting portions 475 at a periphery of the opening of the cavity 474. The device mounting portions 475 are configured for releasable engagement with corresponding mounting portions 469 of the membrane 407. In this way, as is shown in FIG. 25A, the membrane 407 can be secured along the periphery of the opening so as to seal the opening of the cavity 474. The body 473 further comprises two outlets 477 that are each fluidly connected to a respective riser 478 downstream of the outlet 477.

The installation device 472 is configured to draw the membrane 407 into the cavity 474 to facilitate mounting of the membrane 407 to the cell body 433. This configuration is shown in FIG. 25B. In this figure, the installation device 472 has been lowered to the submerged cell body 433 such that it is also submerged (i.e. below the free surface 479 of a body of water). As a result, the pressure external to the installation device 472 has increased (i.e. is above atmospheric). However, the pressure in the cavity 474 remains the same during this lowering, because the risers 478 maintain fluid communication between the cavity 474 and the atmosphere. The result of this is that the pressure of the fluid in the cavity 474 is less than that externally of the cavity 474 and the membrane 407 is thus drawn into the cavity 474.

In the present embodiment, because the risers 478 remain open, as the installation device 472 is lowered, the membrane 407 is gradually drawn into the cavity 474 (due to the gradual increase in pressure differential). In other embodiments, the risers 478 may comprise a closure (e.g. cap, bung, valve, etc.) which may be opened once the installation device 472 has been lowered to the cell body 433 (i.e. providing more rapid drawing in of the membrane 407).

Accordingly, the membrane 407 is moved into a position that makes it easier to mount it onto the cell body 433. In particular, in this position the membrane 407 can be received over and around a peripheral lip 463 of the cell body 433. The membrane 407 can then be disconnected from the installation device 472 and subsequently connected to the cell body 433 by engagement of the membrane mounting portions 469 with corresponding membrane retaining portions 468 of the cell body 433.

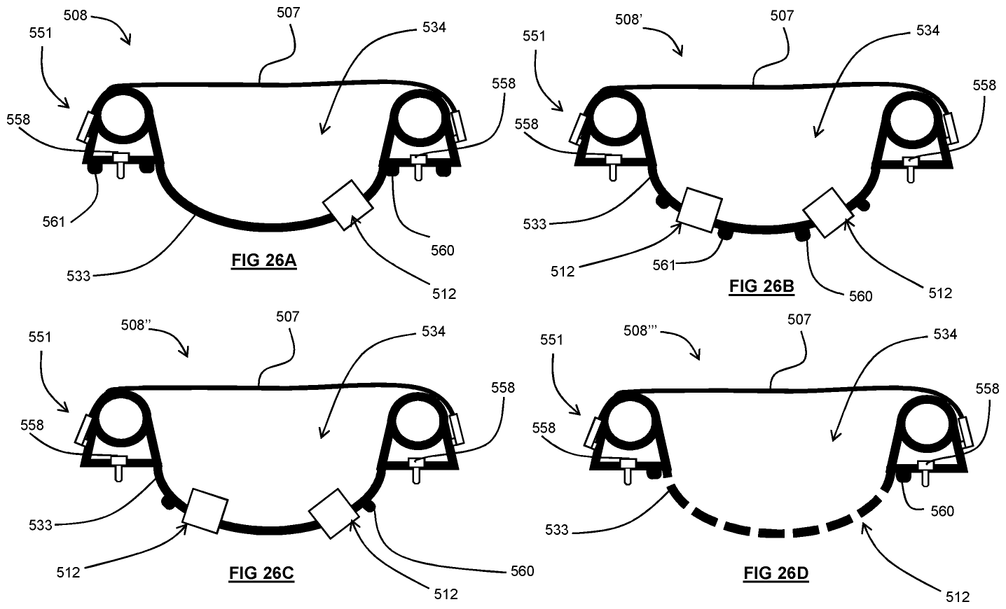

FIGS. 26A to 26D schematically illustrate further WEC module embodiments. Each of these embodiments includes similar features, and for that reason the same reference numerals have been used to designate the same features. Each module includes a membrane 507 extending across an aperture defined by support frame 551, which forms part of a cell body 533. Together, the cell body 533 and membrane 507 define a chamber 534 for a working fluid (such as air). Each module can be mounted to a base structure via mounting portions 558 provided on the support frame 551.

FIG. 26A illustrates an embodiment in which the module 508 includes a single fluid exchange port 512 in the form of an aperture formed in the cell body. The fluid exchange port 512 is configured for fluid flow both into and out of the chamber 534.

The module includes inner 560 and outer 561 peripheral deformable sealing members disposed on the support frame 551. The sealing members 560, 561 extend for the entire periphery of the support frame 551 so as to seal the module 508 to a base structure when mounted thereto. In particular, the sealing members 560, 561 prevent leakage of working fluid from the chamber 534.

In FIG. 26B, the module 508′ comprises two fluid exchange ports 512. Each fluid exchange port 512 may be configured for one-way flow of fluid therethrough (e.g. may comprise a one-way valve). Alternatively, both fluid exchange ports 512 may permit fluid flow in both directions.

In this embodiment, the module 508′ includes two sealing members 560, 561 that each extend about a respective fluid exchange port 512. By doing so, the sealing members 560, 561 seal the fluid exchange ports 512 and prevent leakage of working fluid from the chamber 534.

In FIG. 26C, the module 508″ again includes two fluid exchange ports 512, but instead of having two deformable sealing members, a single sealing member 560 extends about both fluid exchange ports 512.

In FIG. 26D, the module 508′″ the cell body 533 is formed of a mesh so as to comprise a plurality of closely spaced fluid exchange ports 512. A single peripheral sealing member 560 is provided on the support frame 551. In this embodiment a pump may be required as part of the base structure to discharge any water held in the cell body 533.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful and is not intended to exclude other embodiments from the scope of the disclosure, or from the scope of the claims.

1-44. (canceled)

45. A wave energy (WEC) module for connection to a WEC system having a power take-off (PTO) configured to generate electricity in response to fluid flow in a fluid flow path of the system, the WEC module comprising:
a mounting portion for releasably mounting the module to the system;
a deformable sealing member configured to provide a sealed fluid connection between the module and the fluid flow path; and
a working surface configured to exchange, in response to wave motion, a working fluid with the fluid flow path via the sealed fluid connection.

46. A WEC module according to claim 45 comprising a support frame defining an aperture that is sealed by the working surface.

47. A WEC module according to claim 46 wherein the support frame comprises a module sealing face for sealing against a corresponding system sealing surface of a cell body of the system, the deformable sealing member disposed on the module sealing face.

48. A WEC module according to claim 47 wherein the module sealing face forms part of a moveable portion of the support frame that is moveable between a retracted position and a sealing position in which the deformable sealing member seals against the system sealing face.

49. A WEC module according to claim 46 wherein the support frame comprises a guide portion configured to guide the module onto a base structure of the system, one or more surfaces of the guide portion tapering outwardly in a direction of movement of the module during connection to the base structure.

50. A WEC module according to claim 45 comprising a cell body defining an aperture, the working surface sealing the aperture such that a chamber for storage of the working fluid is defined by the cell body and the working surface.

51. A WEC module according to claim 50 wherein the module comprises a fluid exchange port for exchanging fluid between the chamber and the fluid flow path via the sealed connection, the fluid exchange port comprising a module sealing face for sealing with a corresponding system sealing face of the fluid flow path, and wherein the deformable sealing member is disposed on the module sealing face.

52. A WEC module according to claim 51 wherein the module sealing face of the fluid exchange port forms part of a moveable portion of the fluid exchange port that is moveable between a retracted position and a sealing position in which the deformable sealing member seals against the system sealing face.

53. A WEC module according to claim 45 wherein the deformable sealing member is inflatable.

54. A WEC module according to claim 45 wherein the module is configured such that, when mounted to the system, the working surface extends along a substantially horizontal plane.

55. A WEC module according to claim 45 wherein the mounting portion is a first mounting portion and the module comprises a second mounting portion spaced from the first mounting portion, one or both of the first and second mounting portions being moveable such that a distance between the mounting portions can be altered.

56. A WEC system comprising:
a power take-off (PTO) device for generating electricity from flow of a working fluid;
a fluid flow path in fluid connection with the PTO device;
a plurality of WEC modules, each module fluidly connected to the fluid flow path and configured to exchange working fluid with the fluid flow path in response to wave motion; and
a plurality of fluid exchange ports, each fluid exchange port releasably connecting a respective module to the fluid flow path and comprising a deformable sealing element arranged to seal the connection between the respective module and the fluid flow path.

57. A WEC system according to claim 56 wherein the plurality of WEC modules are mounted to one another, such that the fluid flow path is defined by the WEC modules.

58. A WEC system according to claim 56 wherein each WEC module is comprising a support frame defining an aperture that is sealed by the working surface.

59. A WEC system according to claim 56 wherein each WEC module is comprising a cell body defining an aperture, the working surface sealing the aperture such that a chamber for storage of the working fluid is defined by the cell body and the working surface.

60. A WEC system according to claim 57 wherein the WEC modules are mounted to a base structure and the fluid flow path is defined by at least one duct of the base structure.

61. A WEC system according to claim 56 wherein the fluid flow path comprises a debris separator upstream of the PTO, and wherein:
the debris separator comprises a grille and debris trap disposed in horizontal portion of the fluid flow path, and the grille is inclined across the fluid flow path so as to at least partly overhang debris trap; or
the debris separator comprises a grille extending across a vertical portion of the fluid flow path so as to be oriented substantially horizontally and a debris trap disposed below grille.

62. A WEC system according to claim 56 wherein each WEC module comprises first and second mounting portions for engagement with respective first and second receiving portions of the base structure, and wherein at least one of the mounting portions is moveable such that the mounting portions are moveable between a retracted and expanded position.

63. A WEC system according to claim 62 wherein the base structure comprises a plurality of docking stations, each for receipt of a respective WEC module, and each docking station comprises first and second receiving portions for engagement with the first and second mounting portions of the respective WEC module.

64. A WEC system according to claim 63 wherein the first receiving portion comprises a hook-shaped recess having an entrance region and a locking region that extends perpendicularly to the entrance region.
